(19) United States
(12) Patent Application Publication
(10) Pub. No.: US 2006/0045272 A1
(43) Pub. Date: Mar. 2, 2006

(54) Control program, communication relay apparatus control method, communication relay apparatus, and system

(76) Inventor: Satoshi Ohaka, Kawasaki (JP)

Correspondence Address: KATTEN MUCHIN ROSENMAN LLP, 575 MADISON AVENUE, NEW YORK, NY, 10022-2585, US

(21) Appl. No.: 10/999,316

(22) Filed: Nov. 29, 2004

(30) Foreign Application Priority Data
Aug. 26, 2004 (JP) 2004-246553

(51) Int. Cl. H04K 1/00

(52) U.S. Cl. 380/270

(57) ABSTRACT

Connection information of an access point and authentication information of a terminal connected by a wireless LAN are set by an instruction from an access point setting terminal. A memory card in which the set information and the authentication information have been copied is connected to the terminal and the setting of the terminal is made. A combination of an MAC address of the terminal and the authentication information is registered into an association table of the access point. When the combination of the MAC address and the authentication information received by a connecting request is correct, the connection is permitted. The registration of the MAC address and the authentication information by an illegal use terminal is deleted in association with erasure of the set authentication information in order to copy into the memory card again and the subsequent connection of the illegal use terminal is refused. The setting of the connection information to connect to the access point by the wireless LAN and the authentication information can be easily made. When illegal use of the authentication information is determined, it can be simply and certainly eliminated.

### BACKGROUND OF THE INVENTION

1. Field of the Invention

The invention relates to a control program, a communication relay apparatus control method, a communication relay apparatus, and a system for setting connection information and security information into an access point and a terminal of a wireless LAN and, more particularly, to a control program, a communication relay apparatus control method, a communication relay apparatus, and a system for setting connection information and security information into a terminal by using a memory card.

2. Description of the Related Arts

Hitherto, a wireless LAN has been known as a LAN which does not use a wired cable and the wireless LAN which conforms with IEEE802.11 has been widespread. The following three standards can be given as existing wireless LANs which conform with IEEE802.11: IEEE802.11b; IEEE802.11g; and IEEE802.11a. In IEEE802.11b, a radio wave of a band of 2.4 GHz is used, a spread spectrum communication system is used as a communication system, and a maximum transfer speed of 11 Mbps is realized. Likewise, in IEEE802.11g, a radio wave of a band of 2.4 GHz is used, an orthogonal frequency multiplex division system is used as a communication system, and a maximum transfer speed of 54 Mbps is realized. Further, in IEEE802.11a, a radio wave of a band of 5 GHz is used, the orthogonal frequency multiplex division system is used as a communication system, and a maximum transfer speed of 54 Mbps is realized.

In such a wireless LAN, in order to connect a terminal (client) such as a personal computer or the like to an access point by the wireless LAN, information which has been set to the access point needs to be set at a terminal. In the wireless LAN, there is a high risk of illegal use because the radio wave leaks to the outside or the like. In recent years, authentication is made to raise security of the connection between the access point and the terminal.

It is necessary to set authentication information into the terminal side for the purpose of making authentication by the access point of the wireless LAN. For example, certificate data which is issued by an authentication server is installed into the terminals which are connected by using a network or various media. At this time, there is a case where a password is inputted to enhance the security. There is also a case where when the access point is connected, a user name, a password, and the like are inputted to the authentication server. Further, when there is no authentication server, generally, terminal identifiers of the terminals are registered into the access point and the connection is restricted. (Refer to JP-A-7-58749, JP-A-2003-188788, JP-A-10-222468, and JP-A-10-171909.) However, in the conventional wireless LAN, to connect the terminal to the access point, the information set into the access point is set by the user at the terminal by using a utility or the like. However, there is such a problem that such a setting is difficult to an inexperienced person and it takes much labor and time. Although the security of the connection between the access point and the terminal is raised by making the authentication, in many cases, even in the case of the unique authentication information, impersonation is possible by duplicating it. To prevent it, when the user installs the authentication information, it is necessary to execute such troublesome operation as to input the password to thereby raise the security, previously registers an MAC address, and the like. There is consequently such a problem that it takes much labor and time to set the security information in addition to the setting of the connection information.

Further, even if the connection between the access point and the terminal has been authenticated, in the case where the third party illegally obtained the authentication information which is used by the user, passed in the authentication of the access point, and illegally obtained the connection permission, even when the legal user requests the connection by using the authentication information which had illegally been used, such a request is refused, so that it is necessary to newly obtain another authentication information and get connection permission. However, according to the above construction, the connection of the terminal which illegally uses the authentication information to the access point cannot be eliminated but remains and there is such a problem that a special operation for examining a set state of the authentication information as a target of the illegal use for the access point and deleting it has to be executed.

### SUMMARY OF THE INVENTION

According to the invention there are provided a control program, a communication relay apparatus control method, a communication relay apparatus, and a system in which setting of connection information for connecting to an access point by a wireless LAN and authentication information is made easy and, when illegal use of the authentication information is discriminated, it can be easily and certainly eliminated.

(Control Program)

According to the invention, there is provided a control program which is executed by a communication relay apparatus functioning as an access point 10 which is connected to a communicating apparatus functioning as a terminal 12 by a wireless network (wireless LAN) on the assumption that a portable storing medium such as a memory card 18 or the like can be connected to the communication relay apparatus.

According to the invention, there is provided a control program for allowing a computer to execute:

an information setting step wherein connection information of a communication relay apparatus and authentication information of a communicating apparatus for setting information (terminal 14 for setting an access point) which is connected by a wireless network are set by an instruction from the communicating apparatus;

a set information copying step wherein the connection information and the authentication information are copied into a portable recording medium connected to the communication relay apparatus;

a connection permitting step wherein when a first connecting request is received from the communicating apparatus in which the connection information and the authentication information of the wireless network have been set by the connection of the portable recording medium such as a memory card 18 or the like, a combination of an identifier of the communicating apparatus and the authentication information is registered into management information under the condition that the received authentication information is correct and the communicating apparatus is notified of connection permission; and

a connection processing step wherein when the connecting request is received from the communicating apparatus after the notification of the connection permission, a received combination of the identifier of the communicating apparatus and the authentication information is compared with the combination of the identifier of the communicating apparatus and the authentication information registered in the management information, when the combination is correct, the connection is permitted, and when the combination is incorrect, the connection is refused.

In the set information copying step, if the set authentication information has been copied into the portable recording medium connected to the communication relay apparatus, the set copy information is deleted from the portable recording medium and the management information and, thereafter, the set information instructed from the information setting communicating apparatus and new authentication information are copied.

According to another aspect of the invention, there is provided a control program which is executed by a communication relay apparatus functioning as an access point 10 which is connected to a communicating apparatus functioning as a terminal 12 by a wireless network on the assumption that a portable storing medium such as a memory card 18 or the like cannot be connected to the communication relay apparatus and the portable storing medium can be connected to a communicating apparatus for setting information functioning as a terminal 14 for setting the access point.

According to the invention, there is provided a control program for allowing a computer of a communication relay apparatus which is connected to a communicating apparatus by a wireless network to execute:

an information setting step wherein connection information of the communication relay apparatus and authentication information of the communicating apparatus which is connected by the wireless network are set by an instruction from the communicating apparatus for setting information;

a set information copying step wherein the connection information and the authentication information are copied into a portable recording medium connected to the information setting communicating apparatus;

a connection permitting step wherein when a first connecting request is received from the communicating apparatus in which the connection information and the authentication information of the wireless network have been set by the connection of the portable recording medium, a combination of an identifier of the communicating apparatus and the authentication information is registered into management information under the condition that the received authentication information is correct and the communicating apparatus is notified of connection permission; and

a connection processing step wherein when the connecting request is received from the communicating apparatus after the notification of the connection permission, a received combination of the identifier of the communicating apparatus and the authentication information is compared with the combination of the identifier of the communicating apparatus and the authentication information registered in the management information, when the combination is correct, the connection is permitted, and when the combination is incorrect, the connection is refused.

In the information setting step, the set authentication information is deleted from the management information on the basis of a deleting instruction of-the set authentication information in the case where the set authentication information has been copied into the portable recording medium from the information setting communicating apparatus and, thereafter, the set information instructed from the information setting communicating apparatus and new authentication information are set into the portable recording medium.

In the control program of the invention, the identifier of the communicating apparatus is an MAC address of the communicating apparatus.

(Communication Relay Apparatus Control Method)

The invention provides a communication relay apparatus control method. The communication relay apparatus control method according to the invention comprises:

an information setting step wherein connection information of a communication relay apparatus and authentication information of a communicating apparatus which is connected by a wireless network are set by an instruction from a communicating apparatus for setting information;

a set information copying step wherein the connection information and the authentication information are copied into a portable recording medium connected to the communication relay apparatus;

a connection permitting step wherein when a first connecting request is received from the communicating apparatus in which the connection information and the authentication information of the wireless network have been set by the connection of the portable recording medium, a combination of an identifier of the communicating apparatus and the authentication information is registered into management information under the condition that the received authentication information is correct and the communicating apparatus is notified of connection permission; and

a connection processing step wherein when the connecting request is received from the communicating apparatus after the notification of the connection permission, a received combination of the identifier of the communicating apparatus and the authentication information is compared with the combination of the identifier of the communicating apparatus and the authentication information registered in the management information, when the combination is correct, the connection is permitted, and when the combination is incorrect, the connection is refused.

In the set information copying step, if the set authentication information has been copied into the portable recording medium connected to the communication relay apparatus, the set copy information is deleted from the portable recording medium and the management information and, thereafter, the set information instructed from the information setting communicating apparatus and new authentication information are copied.

According to another aspect of the invention, there is provided a communication relay apparatus control method comprising:

an information setting step wherein connection information of a communication relay apparatus and authentication information of a communicating apparatus which is connected by a wireless network are set by an instruction from a communicating apparatus for setting information;

a set information copying step wherein the connection information and the authentication information are copied into a portable recording medium connected to the information setting communicating apparatus;

a connection permitting step wherein when a first connecting request is received from the communicating apparatus in which the connection information and the authentication information of the wireless network have been set by the connection of the portable recording medium, a combination of an identifier of the communicating apparatus and the authentication information is registered into management information under the condition that the received authentication information is correct and the communicating apparatus is notified of connection permission; and

a connection processing step wherein when the connecting request is received from the communicating apparatus after the notification of the connection permission, a received combination of the identifier of the communicating apparatus and the authentication information is compared with the combination of the identifier of the communicating apparatus and the authentication information registered in the management information, when the combination is correct, the connection is permitted, and when the combination is incorrect, the connection is refused.

In the information setting step, the set authentication information is deleted from the management information on the basis of a deleting instruction of the set authentication information in the case where the set authentication information has been copied into the portable recording medium from the information setting communicating apparatus and, thereafter, the set information instructed from the information setting communicating apparatus and new authentication information are set into the portable recording medium.

(Communication Relay Apparatus)

The invention provides a communication relay apparatus. On the assumption that a portable recording medium can be connected, the communication relay apparatus according to the invention comprises:

an information setting unit which sets connection information of the communication relay apparatus and authentication information of a communicating apparatus which is connected by a wireless network by an instruction from a communicating apparatus for setting information;

a set information copying unit which copies the connection information and the authentication information into the connected portable recording medium;

a connection permitting unit which, when a first connecting request is received from the communicating apparatus in which the connection information and the authentication information of the wireless network have been set by the connection of the portable recording medium, registers a combination of an identifier of the communicating apparatus and the authentication information into management information under the condition that the received authentication information is correct and notifies the communicating apparatus of connection permission; and

a connection processing unit which, when the connecting request is received from the communicating apparatus after the notification of the connection permission, compares a received combination of the identifier of the communicating apparatus and the authentication information with the combination of the identifier of the communicating apparatus and the authentication information registered in the management information, permits the connection when the combination is correct, and refuses the connection when the combination is incorrect.

If the set authentication information has been copied into the portable recording medium connected to the communication relay apparatus, the set information copying unit deletes the set copy information from the portable recording medium and the management information and, thereafter, copies the set information instructed from the information setting communicating apparatus and new authentication information.

On the assumption that a communication relay apparatus does not have a connecting function of a portable recording medium, the communication relay apparatus according to another aspect of the invention comprises:

an information setting unit which sets connection information of the communication relay apparatus and authentication information of a communicating apparatus which is connected by a wireless network by an instruction from a communicating apparatus for setting information;

a set information copying unit which copies the connection information and the authentication information into the portable recording medium connected to the information setting communicating apparatus;

a connection permitting unit which, when a first connecting request is received from the communicating apparatus in which the connection information and the authentication information of the wireless network have been set by the connection of the portable recording medium, registers a combination of an identifier of the communicating apparatus and the authentication information into management information under the condition that the received authentication information is correct and notifies the communicating apparatus of connection permission; and

a connection processing unit which, when the connecting request is received from the communicating apparatus after the notification of the connection permission, compares a received combination of the identifier of the communicating apparatus and the authentication information with the combination of the identifier of the communicating apparatus and the authentication information registered in the management information, permits the connection when the combination is correct, and refuses the connection when the combination is incorrect.

The information setting unit deletes the set authentication information from the management information on the basis of a deleting instruction of the set authentication information in the case where the set authentication information has been copied into the portable recording medium from the information setting communicating apparatus and, thereafter, sets the set information instructed from the information setting communicating apparatus and new authentication information into the portable recording medium.

(System)

The invention provides a system of a wireless network. The system of the invention comprises:

a communication relay apparatus to which a portable recording medium is connected;

a communicating apparatus which is connected to the communication relay apparatus by the wireless network and to which the portable recording medium can be connected; and

an information setting communicating apparatus for instructing the communication relay apparatus to set connection information and authentication information of the communicating apparatus,

wherein the communication relay apparatus comprises:

an information setting unit which sets the connection information of the communication relay apparatus and the authentication information of the communicating apparatus which is connected by the wireless network by the instruction from the information setting communicating apparatus;

a set information copying unit which copies the connection information and the authentication information into the connected portable recording medium;

a connection permitting unit which, when a first connecting request is received from the communicating apparatus in which the connection information and the authentication information of the wireless network have been set by the connection of the portable recording medium, registers a combination of an identifier of the communicating apparatus and the authentication information into management information under the condition that the received authentication information is correct and notifies the communicating apparatus of connection permission; and

a connection processing unit which, when the connecting request is received from the communicating apparatus after the notification of the connection permission, compares a received combination of the identifier of the communicating apparatus and the authentication information with the combination of the identifier of the communicating apparatus and the authentication information registered in the management information, permits the connection when the combination is correct, and refuses the connection when the combination is incorrect.

If the set authentication information has been copied into the portable recording medium connected to the communication relay apparatus, the set information copying unit of the communication relay apparatus deletes the set copy information from the portable recording medium and the management information and, thereafter, copies the set information instructed from the information setting communicating apparatus and new authentication information.

According to another aspect of the invention, there is provided a wireless network system comprising:

a communication relay apparatus;

a communicating apparatus which is connected to the communication relay apparatus by a wireless network and to which a portable recording medium can be connected; and

an information setting communicating apparatus to which the portable recording medium is connected and which instructs the communication relay apparatus to set connection information and authentication information of the communicating apparatus, wherein the information setting communicating apparatus comprises:

an information setting instructing unit which instructs the setting of the connection information of the communication relay apparatus and the authentication information of the communicating apparatus which is connected by the wireless network; and

a card copy processing unit which copies the connection information and the authentication information whose setting has been instructed to the communication relay apparatus into the connected portable recording medium, and

the communication relay apparatus comprises:

an information setting unit which sets the connection information of the communication relay apparatus and the authentication information of the communicating apparatus which is connected by the wireless network by the instruction from the information setting communicating apparatus;

a set information copying unit which copies the connection information and the authentication information into the portable recording medium connected to the information setting communicating apparatus;

a connection permitting unit which, when a first connecting request is received from the communicating apparatus in which the connection information and the authentication information of the wireless network have been set by the connection of the portable recording medium, registers a combination of an identifier of the communicating apparatus and the authentication information into management information under the condition that the received authentication information is correct and notifies the communicating apparatus of connection permission; and

a connection processing unit which, when the connecting request is received from the communicating apparatus after the notification of the connection permission, compares a received combination of the identifier of the communicating apparatus and the authentication information with the combination of the identifier of the communicating apparatus and the authentication information registered in the management information, permits the connection when the combination is correct, and refuses the connection when the combination is incorrect.

On the basis of a deleting instruction of the set authentication information in the case where the set authentication information has been copied into the portable recording medium from the information setting communicating apparatus, the information setting unit deletes the set authentication information from the management information and, thereafter, sets the set information instructed from the information setting communicating apparatus and new authentication information into the portable recording medium.

According to the invention, the connection information set into the access point is copied into a memory card by an instruction of an access point setting terminal, this memory card is connected to a terminal (wireless LAN client) to be connected to the access point, and the connection information is set, so that the setting operation at the terminal can be simply and easily executed.

Since the authentication information is also copied into the memory card and connected to the terminal (wireless LAN client), the authentication information can be expanded to the permitted maximum number of digits and simply and easily set into the terminal. The security in the case where the connection of the access point and the terminal is made by the authentication can be enhanced to the maximum.

With respect to the terminal which was notified of the connection permission, the combination of the identifier of the terminal and the authentication information, for example, the combination of the MAC address and the authentication information is registered into the access point. By permitting the connection when the combination is correct and refusing the connection when the combination is incorrect, the security can be enhanced.

Further, even if the combination of the identifier of the illegal terminal and the authentication information has been registered, by copying the set information and the authentication information again by using the memory card in which the authentication information which was illegally used has been copied in response to the connecting request from the illegal use terminal which illegally obtained the authentication information, the authentication information of the illegal use terminal registered in the access point is automatically deleted. Therefore, after that, in response to the connecting request from the illegal use terminal, since the combination of the identifier of the terminal and the authentication information becomes incorrect, the connection is refused and the illegal use terminal can be eliminated from the access point.

The above and other objects, features, and advantages of the present invention will become more apparent from the following detailed description with reference to the drawings.

### BRIEF DESCRIPTION OF THE DRAWINGS

FIG. 1 is an explanatory diagram of a wireless LAN system using an access point having a card slot;

FIG. 2 is a block diagram of a hardware environment of the access point and a terminal in FIG. 1;

FIGS. 3A and 3B are block diagrams of functional constructions of the access point, the terminal, and a terminal for setting the access point in FIG. 1;

FIG. 4 is an explanatory diagram of an association table provided for the access point in FIGS. 3A and 3B;

FIG. 5 is an explanatory diagram of a wireless LAN setting display screen which is displayed at the access point setting terminal in FIGS. 3A and 3B;

FIG. 6 is an explanatory diagram of a security setting display screen which is displayed at the access point setting terminal in FIGS. 3A and 3B;

FIG. 7 is a correspondence explanatory diagram of access point set items and terminal set items which were set by the setting display screens in FIGS. 5 and 6;

FIGS. 8A, 8B, and 8C are explanatory diagrams of set data which is held in the access point in correspondence to the set items in FIG. 7;

FIGS. 9A and 9B are time charts for a setting process between the access point setting terminal and the access point in FIGS. 3A and 3B;

FIGS. 10A and 10B are time charts for a connecting process between the terminal and the access point in FIGS. 3A and 3B;

FIG. 11 is a flowchart for an authentication connecting process by the access point in FIGS. 3A and 3B;

FIG. 12 is a flowchart for an authentication connecting process by the terminal in FIGS. 3A and 3B;

FIG. 13 is an explanatory diagram of connection permission to a connecting request from an illegal user terminal which illegally used authentication information copied into a memory card in FIGS. 3A and 3B and an explanatory diagram of subsequent connection refusal to a legal user terminal;

FIG. 14 is an explanatory diagram of in the case of refusing the connecting request from the legal user terminal after the illegal user terminal in FIG. 13 was notified of the connection permission;

FIG. 15 is an explanatory diagram in the case where the authentication information which was illegally used is deleted from the access point when the legal user copies the authentication information into the memory card again;

FIG. 16 is an explanatory diagram in the case where the connecting request by the legal user terminal after the authentication information was copied into the memory card again is permitted;

FIG. 17 is an explanatory diagram in the case where the connecting request by the illegal user terminal after the authentication information was copied into the memory card again is refused;

FIG. 18 is an explanatory diagram of a wireless LAN system which uses an access point having no card slot and to which the invention is applied;

FIGS. 19A and 19B are block diagrams of functional constructions of the access point, a terminal, and a terminal for setting the access point in FIG. 18; and

FIGS. 20A and 20B are time charts for a setting process between the access point setting terminal and the access point in FIGS. 19A and 19B.

### DETAILED DESCRIPTION OF THE PREFERRED EMBODIMENT

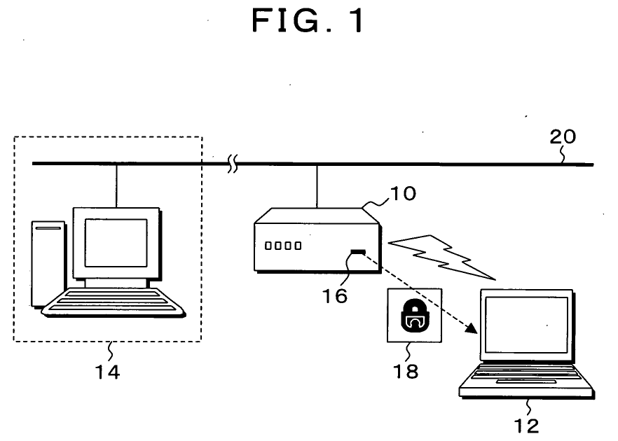

FIG. 1 is an explanatory diagram of a wireless LAN system which uses an access point having a card slot to that a memory card is connected and to which the invention is applied. In FIG. 1, an access point 10 functioning as a communication relay apparatus has a card slot 16. A memory card 18 as a portable storing medium can be inserted and removed into/from the card slot 16. The access point 10 is connected to a wired LAN 20 as a wired network. In response to a setting instruction from an access point setting terminal 14 that is temporarily connected to the wired LAN 20 for a setting operation of the access point 10, the access point 10 can remotely set and register connection information necessary for connection to a terminal 12 as a wireless LAN client and authentication information for security.

When the setting operation of the connection information and the authentication information is executed to the access point 10 by the access point setting terminal 14, the memory card 18 is inserted into the card slot 16 of the access point 10 and connected thereto and at the stage when the setting process of the access point 10 is completed, the connection information which has been set and the authentication information of the terminal 12 connected to the access point 10 are written. A proper memory card such as CF card, smart media, SD card, or the like can be used as a memory card 18. The terminal 12 such as a personal computer or the like which is connected to the access point 10 by a wireless LAN 11 as a wireless network has a card slot (not shown) for connecting the memory card 18. In the state where the memory card 18 in which the connection information and the authentication information have been written at the access point 10 has been inserted into the card slot and connected, the necessary information is read out from the memory card 18 by software installed in the terminal 12 and the connection information necessary for connection to the access point 10 by the wireless LAN and the authentication information can be set.

A setting procedure of the connection information and the authentication information in the wireless LAN system in FIG. 1 will be described hereinbelow. First, the memory card 18 is inserted into the access point 10 and connected. The access point setting terminal 14 is connected to, for example, the wired LAN 20. Setting of the connection information such as SSID (Service Set Identity), an encryption key, and the like into the access point 10 and setting of the authentication information of the terminal 12 such as a personal computer or the like which is connected to the access point 10 by the wireless LAN are performed.

A system which conforms with IEEE802.11 is used as a wireless LAN between the access point 10 and the terminal 12. Encrypted communication known as WEP (Wired Equivalent Privacy) is used for the wireless communication between the access point 10 and the terminal 12. The encryption key necessary for the encrypted communication is issued at the time of the setting process of the access point 10, written as authentication information into the memory card 18, and used for the setting of the authentication information on the terminal 12 side.

A system known as ESSID (SSID) for making authentication between the access point 10 and the terminal 12 by using an encryption is used for the wireless communication between them. Upon setting of the authentication communication by this ESSID, by setting an “ANY” key into the terminal 12 side, the wireless communication using the encryption between the access point 10 and the terminal 12 is enabled. The encryption key as authentication information by the WEP provides a powerful security function. By expanding the encryption key as authentication information to the maximum number of digits which is used at present, the security can be maximally enhanced.

In the WEP for the encrypted communication, a secret key encryption system based on an algorithm called RC4 (Rivest Cipher 4) is used. According to the encrypting algorithm RC4, a random number sequence of 256 bytes is formed and added to a data portion of a frame by the exclusive OR, thereby encrypting. On the reception side, the original data is decrypted by using the same calculating method and getting the same exclusive OR as those on the transmission side by using a transmitted initialization vector.

Since this secret key encryption system uses the same key in both the encryption and the decryption, it is necessary to set the same key into both the access point 10 and the terminal 12. In the invention, however, the encryption key is written into the memory card 18 and can be automatically set into the terminal 12 side by connecting it to the terminal 12. Although one of the numbers of bits of 40 bits, 104 bits, and 128 bits can be used as an encryption key of the WEP, desirably, by setting the encryption key to a key length expanded to 128 bits as the maximum number of digits, the security is maximized.

Explaining further in detail, there are two kinds of length of 64 bits and 128 bits as an encryption key length. The initialization vector of 24 bits among them is automatically formed as a fixed value on the apparatus side and the secret key set by an external instruction is combined with it. The length of secret key which needs to be set by the external instruction is equal to 40 bits or 104 bits. However, since a possibility of decipherment due to a tournament method remains in the case of the secret key of 40 bits or 104 bits, the length of secret key is set so as to cope with 128 bits, thereby actually disabling the decipherment due to the tournament method.

In the invention, after the authentication information as an encryption key for the WEP is written into the memory card 18, the memory card is connected to the terminal 12 and the authentication information can be set. Therefore, even if the length of encryption key is increased to the maximum number of digits, the setting operation can be executed by the writing and reading into/from the memory card 18. Consequently, even if the key length is expanded to the maximum number of digits, the authentication information can be easily set to the terminal 12 side. When the setting process of the connection information and the authentication information by the access point setting terminal 14 of the access point 10 is finished as mentioned above, the access point 10 writes the connection information and the unique authentication information of each terminal 12 into the memory card 18 at the end of the setting.

Subsequently, the memory card 18 in which the connection information and the authentication information have been written is removed from the access point 10 and inserted into the card slot of the terminal 12 such as a personal computer or the like to be connected to the access point 10 by the wireless LAN and connected to the access point 10. The necessary information is read out from the memory card 18 by wireless LAN setting software installed in the terminal 12 and the setting process necessary for the wireless LAN in the terminal 12 is executed. After completion of the setting regarding the wireless LAN of the terminal 12 based on the memory card 18, an access to obtain the permission of the communication connection is made from the terminal 12 to the access point 10 on the basis of the set information. The access to obtain the communication permission is executed in order of the access point searching operation, authenticating operation, and further associating operation by the terminal 12.

In the access point searching operation, the terminal 12 transmits a probe requesting packet by using all of its own channels which can be communication connected and recognizes the connectable access point by receiving a probe response packet from the access point 10 which received the probe requesting packet. Specifically speaking, a list of the names of the networks designated by the SSID of the access point 10 which can be connected is displayed at the terminal 12. At the terminal 12, the network corresponding to one of the network names shown by the SSID of the access point which returned the probe response packet is selected and the authenticating operation and the associating operation are executed.

In the authenticating operation, the terminal 12 issues an authenticating request to the access point 10 before the access point 10 is determined and the association is executed. The access point 10 returns an authentication response and, at the same time, transmits a challenge text of a length of 3 to 255 bytes. The terminal 12 encrypts the received challenge text by the encryption key and returns it as a response message to the access point 10. If the message decrypted by using the same encryption key coincides with the challenge text which was sent first, the access point 10 finishes the access authentication as successful authentication.

In the associating operation, an association request packet is transmitted to the access point 10 in which the authentication is successful. The access point 10 which received the association request packet registers a terminal name, for example, an MAC address as an identifier peculiar to the terminal into an association table as a management table which manages the connection to the terminals and returns an association response packet indicative of the connection permission. Thus, a communication permitting state is established in the terminal 12 by providing an association identifier which is transmitted to the access point 10. The communication by the wireless LAN is connected between the access point 10 and the terminal 12 hereinafter on the basis of the processes at the application level.

When the access point 10 succeeds in the authentication of the terminal 12 and executes the associating operation, the access point 10 registers a combination of the MAC address as an identifier of the terminal 12 and the authentication information into the association table as a management table and, thereafter, transmits the association response packet for notifying the terminal 12 of the communication permission. Therefore, after the combination of the MAC address of the terminal 12 and the authentication information is registered into the association table and the communication permission is established, if there is a connecting request from the terminal 12, that is, if there are an authenticating request and a reassociating request in association with the power-ON or the like of the terminal, the combination of the authentication information and the MAC address of the terminal 12 received by the connecting request after the success in the authentication is collated with the combination of the MAC address and the authentication information registered in the association table. If it is determined that the combination is correct, the communication connection is permitted.

The connection permission to the connecting request of the terminal 12 is performed in the access point 10 on the basis of the combination of the MAC address and the authentication information as mentioned above, so that the security against the illegal access can be remarkably enhanced as compared with that in the connection permission according to the authentication of only the authentication information or only the MAC address.

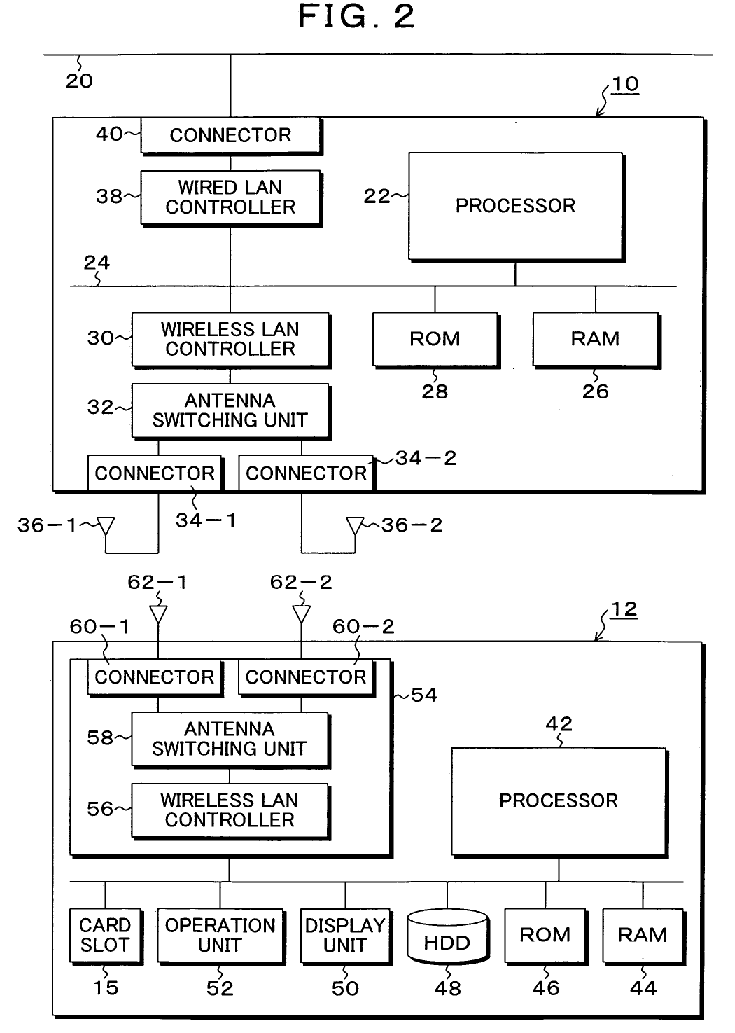

FIG. 2 is a block diagram of a hardware environment of the access point and the terminal in FIG. 1. In FIG. 2, a processor 22 is provided in the access point 10. A RAM 26, a ROM 28, a wireless LAN controller 30, and a wired LAN controller 38 are connected to the processor 22 through a bus 24. Antennas 36-1 and 36-2 are connected to the wireless LAN controller 30 through an antenna switching unit 32 by connectors 34-1 and 34-2. The wired LAN controller 38 is connected to the wired LAN 20 through a connector 40. The wireless LAN controller 30 has processing functions necessary for the setting process of the connection information and the authentication information according to the invention. The wireless LAN controller 30 constructs a wireless LAN physical layer, a wireless LAN MAC layer, and an upper layer in accordance with IEEE802.11 and makes wireless communication according to CSMA-CA (carrier detection collision avoidance).

A signal which is superimposed to a radio wave in the wireless LAN is approximate to an Ethernet frame of the wired Ethernet and ordinarily called a MAC frame. It has a frame structure in which information peculiar to the wireless communication is added to the wired Ethernet frame. MAC addresses possessed by network adaptors of a transmitting source and a partner destination are disclosed in a header of the MAC frame.

In the relay operation of the access point 10, the destination MAC address of the Ethernet frame received by the wireless LAN controller 30 is checked. If the partner is located on the wireless LAN, a packet is inputted into the wireless Ethernet frame again and the resultant frame is relayed. If the partner is located on the wired LAN 20, the packet is inputted into the wired Ethernet frame again and the resultant frame is relayed.

The personal computer is shown as an example of the terminal 12. A processor 42 is provided. A RAM 44, a ROM 46, a hard disk drive (HDD) 48, a display unit 50, and an operation unit 52 are connected to the processor 42 through a bus. Further, a card slot 15 for inserting and connecting the memory card 18 is provided for the processor 42. A wireless LAN card 54 is attached into the card slot. The wireless LAN card 54 comprises a wireless LAN controller 56, an antenna switching unit 58, connectors 60-1 and 60-2, and antennas 62-1 and 62-2. Processing functions as software for reading out the necessary information when the memory card 18 in which the set information and the authentication information of the access point 10 side have been written is connected to the card slot 15 and executing the setting process necessary for connection to the access point 10 by the wireless LAN have been installed in the wireless LAN controller 56. The processing functions as software can be also provided as application programs of the processor 42 side.

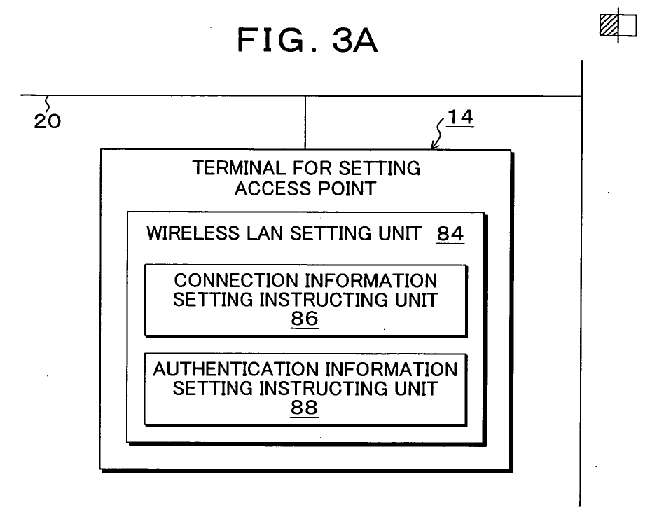

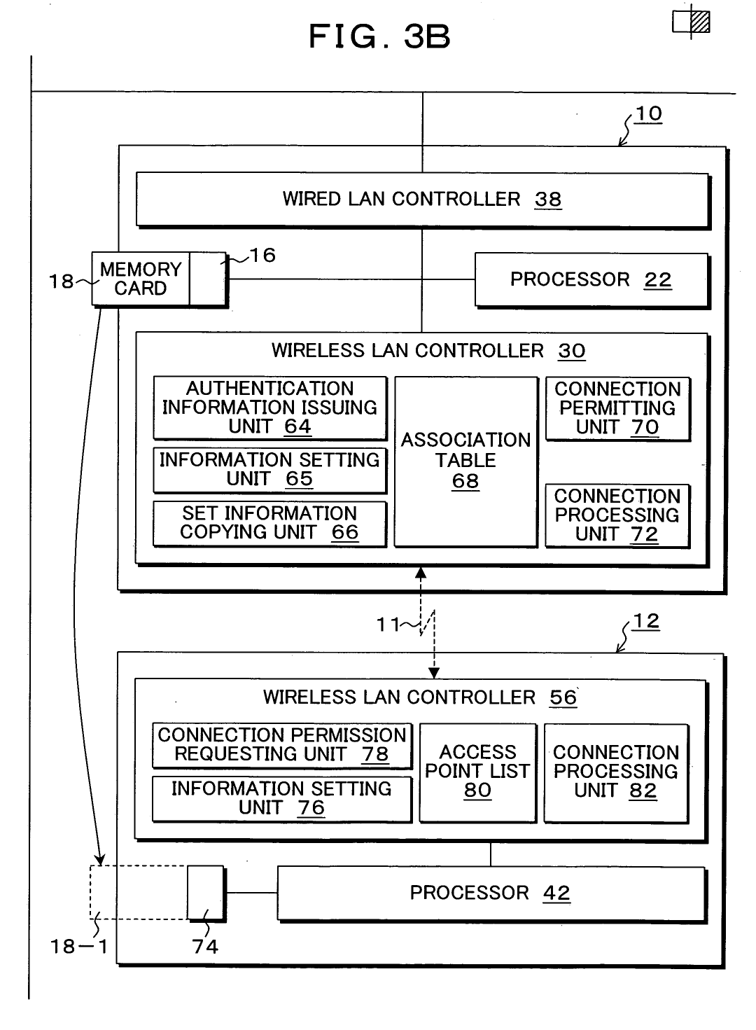

FIGS. 3A and 3B are block diagrams of functional constructions of the access point, the terminal, and the access point setting terminal in FIG. 1. In FIGS. 3A and 3B, functions of an authentication information issuing unit 64, an information setting unit 65, a set information copying unit 66, an association table 68, a connection permitting unit 70, and a connection processing unit 72 are provided for the wireless LAN controller 30 provided in the access point 10. Functions of an information setting unit 76, a connection permission requesting unit 78, an access point list 80, and a connection processing unit 82 are provided for the wireless LAN controller 56 of the terminal 12. Further, a wireless LAN setting unit 84 is provided as a setting application for the access point setting terminal 14. Functions of a connection information setting instructing unit 86 and an authentication information setting instructing unit 88 are provided in the wireless LAN setting unit 84.

When a setting instruction to validate the WEA is received from the access point setting terminal 14, the authentication information issuing unit 64 of the access point 10 issues the encryption key of the key length designated on the basis of a predetermined character string. By an instruction from the access point setting terminal 14, the information setting unit 65 sets the connection information of the access point 10 and the authentication information of the terminal 12 connected by the wireless LAN. When the setting of the connection information and the authentication information in the access point 10 by the information setting unit 65 is completed, the set information copying unit 66 executes the copying process for writing the set connection information and authentication information into the memory card 18 connected to the card slot 16.

At the stage where the terminal 12 completes the setting necessary for the connection of the wireless LAN on the basis of the information in the memory card 18, when the first connecting request by the association request packet is received from the terminal. 12, the connection permitting unit 70 collates the received authentication information with the stored authentication information. Under the condition that the authentication information is correct, the connection permitting unit 70 registers the combination of the MAC address as an identifier of the terminal 12 and the authentication information into the association table 68 as a management table and transmits the association response packet showing the connection permission to the terminal 12.

When the connecting request is received from the terminal 12 after the connection permission of the terminal 12 was notified by the registration of the MAC address and the authentication information into the association table 68, the connection processing unit 72 compares the received combination of the MAC address and the authentication information with the combination of the MAC address and the authentication information registered in the association table 68. If a collation results indicates that they coincide and the combination is correct, the connection is permitted. If the combination is incorrect, the connection is refused.

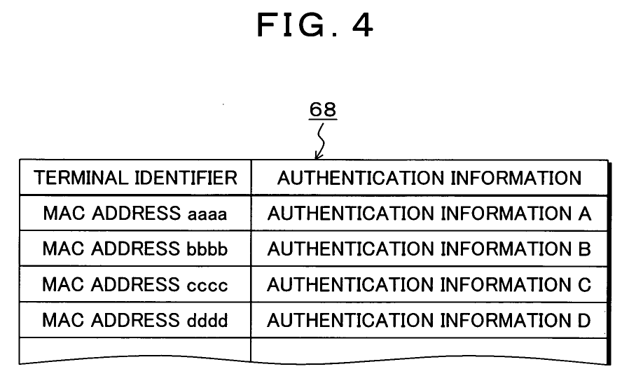

FIG. 4 is an explanatory diagram of the association table 68 provided for the access point 10 in FIGS. 3A and 3B. In the association table 68 in FIG. 4, the combination of the MAC address and the authentication information peculiar to the terminal is registered as a combination of the terminal identifier and the authentication information every terminal notified of the connection permission. In the registration of the combination of the MAC address and the authentication information in the association table 68, in the case where the illegal user illegally obtained the specific authentication information by some reasons and accessed the access point 10 and this information has been registered in the association table 68 as a combination of the MAC address of the terminal of the illegal user and the authentication information which was illegally obtained, even if the inherent legal user makes the connecting request based on the authentication information in the memory card 18, since the MAC address and the authentication information have already been registered by the illegal user terminal, the registration is refused and the connection cannot be performed.

In such a case, the legal user newly inserts the memory card 18 into the access point 10 and instructs the setting of the connection information and the authentication information again to the access point 10 on the basis of the setting instruction by the access point setting terminal 14. After completion of the setting, the legal user writes the connection information and the newly issued authentication information into the memory card 18 and the connection setting is executed again at the terminal 12. In this case, the set authentication information which was issued at the previous time has been written in the memory card 18 connected to the access point 10 due to the reissuance. In the access point 10, when the newly issued authentication information is written into the memory card 18, it is recognized that the set authentication information remains and simultaneously with the deletion of the set authentication information in the memory card 18, the set authentication information is also deleted from the association table 68.

Therefore, among the combinations of the MAC addresses of the illegal user terminals and the authentication information registered in the association table 68, the authentication information of the illegal access terminals is also deleted in association with the deletion of the authentication information in the memory card 18. Thus, when the illegal user terminal makes the connecting request to the access point 10 after the deletion, only the registered MAC addresses of the illegal user terminals remain in the association table 68. Since the combination of the MAC address and the authentication information is sent from the illegal user terminal, it does not coincide with the registration contents in the association table 68. Thus, the subsequent connecting request by the illegal user terminal can be refused.

Referring to FIGS. 3A and 3B again, in the state where the memory card 18 after completion of the information writing by the access point 10 has been inserted and connected into a card slot 74 as shown at reference numeral 18-1, the information setting unit 76 of the terminal 12 reads out the necessary information under the control by the processor 42 and executes the setting process of the connection information and the authentication information necessary for the connection of the wireless LAN to the access point 10.

After completion of the setting of the connection information and the authentication information, the connection permission requesting unit 78 executes the access point searching operation and the associating operation to obtain the permission of the connection to the access point 10. In the access point searching operation, the probe request packet is transmitted by using all channels which can be used in the wireless LAN controller 56 and the SSID of the access point which made a response is registered onto the access point list 80. If a plurality of SSIDs are registered onto the access point list 80, one of them is selected and the association request packet is transmitted to the access point 10. On the access point 10 side, after the MAC address and the authentication information are registered into the association table 68 by the success in the collation of the received authentication information, the association response packet which notifies the terminal of the communication permission is transmitted. By receiving this response packet, the terminal 12 establishes the permitting state of the communication connection to the access point 10. After that, the communicating request associated with the processes of an arbitrary application by the processor 42 is received by the connection processing unit 82 and the connecting request to the access point 10 is made. By receiving the communication permission based on the comparison collation result of the combination of the MAC address and the authentication information in the access point 10, the communicating process by the wireless LAN is executed.

Further, the wireless LAN setting unit 84 provided for the access point setting terminal 14 makes the setting instruction of the connection information to the access point 10 and the authentication information necessary for the terminal 12 to be connected to the access point 10 by using the connection information setting instructing unit 86 and the authentication information setting instructing unit 88. Specifically speaking, the setting instruction of the connection information and the authentication information is made by using a setting display screen by the execution of a utility program provided for the access point setting terminal 14.

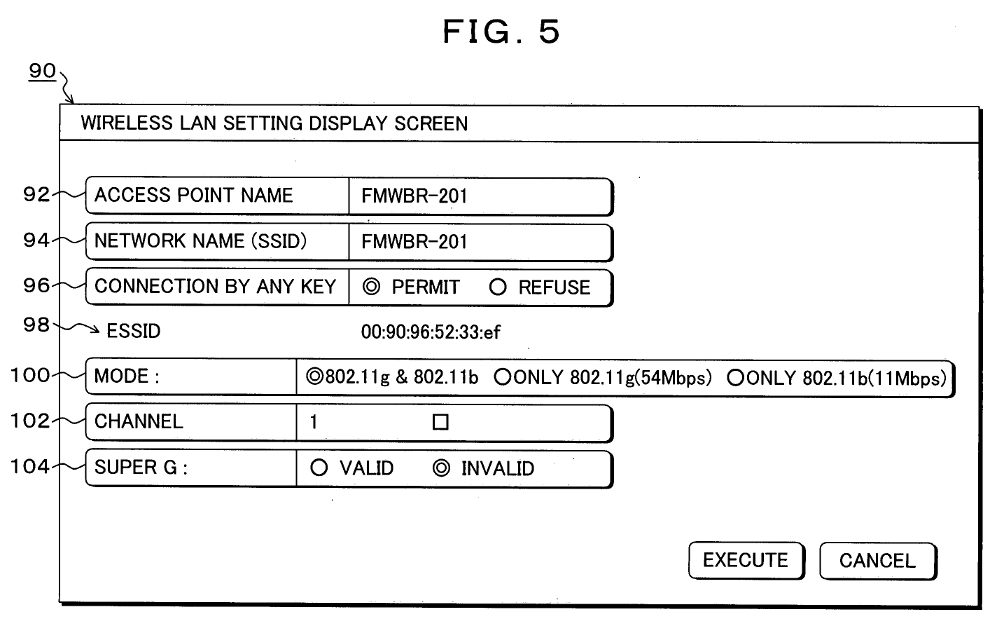

FIG. 5 is an explanatory diagram of a wireless LAN setting display screen 90 which is used at the access point setting terminal 14 in FIGS. 3A and 3B. In the wireless LAN setting display screen 90, an access point name 92, a network name 94, connection 96 by the ANY key, an ESSID 98, a mode 100, a channel 102, and a Super G 104 are set. “Super G” is a system in which the speed of IEEE802.11g is raised by a unique system. For example, “FMWBR-201” as a product name or the like of the access point 10 can be given as an access point name 92. The network name 94 is a network name of the connectable wireless LAN which is displayed as an SSID on the terminal side. For example, the same name “FMWBR-201” as an access point name 92 is set.

Either “permit” or “refuse” is set in the connection 96 by the ANY key. When “permit” is selected with respect to the connection by the ANY key, the connection from the terminal in which the network name is set to “ANY” is also permitted. When “refuse” is selected, the connection only from the terminal in which the same network name as the network name 94 has been set is permitted.

In the mode 100, the communication system in IEEE802.11 is selected. In this example, one of three systems “802.11g & 802.11b”, “only 802.11g”, and “only 802.11b” can be selected. The channel 102 depends on the communication system of the wireless LAN selected in the mode 100. For example, in the case of 802.11g, one of channels “1” to “4” can be selected. In this case, the channel “1” is selected. In the Super G 104, either “valid” or “invalid” is selected. When “valid” is set in the Super G 104, the high-speed communication of the unique system can be made with the terminal in which Super G has been set. If “invalid” is set, the high-speed communication of the unique system is not made.

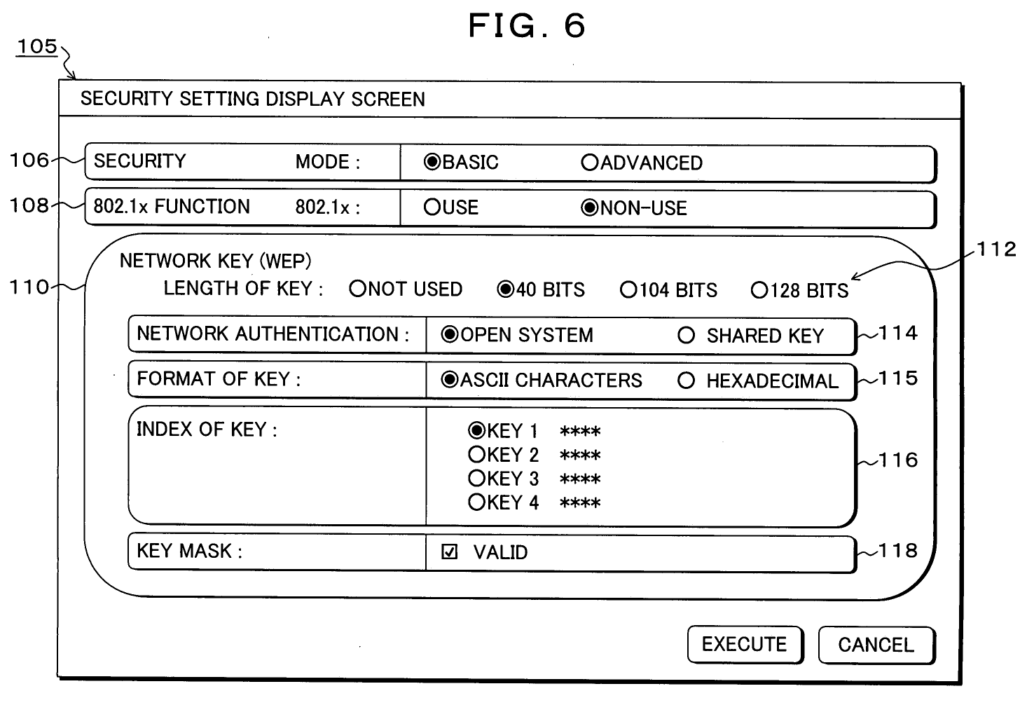

FIG. 6 is an explanatory diagram of a security setting display screen 105 which is displayed at the access point setting terminal 14 in FIGS. 3A and 3B. In the security setting display screen 105, information necessary for the WEP (Wired Equivalent Privacy, privacy that is equivalent to the wired LAN) serving as an encrypting function in the wireless LAN is set. In the security setting display screen 105, a security 106, a 802.1x function 108, and a network key 110 are provided. In the network key 110, items such as key length 112, network authentication 114, key format 115, key index 116, and key mask 118 can be set.

In the mode of the security 106, either “basic” or “advanced” can be selected. In the 802.1x function 108, either “use” or “non-use” is set. In the network key 110, one of “not used”, “40 bits”, “104 bits”, and “128 bits” can be selected. To maximize the security, it is desirable to select “128 bits”. In the network authentication 114, either “open system” or “shared key” can be selected. As another item, one of WPA (Wi-Fi Protested Access: a security function of the wireless LAN defined by the Wi-Fi Alliance and a subset of IEEE801.11), WPA-PSK (WPA2), and the like can be also selected.

As a key index 116, four kinds of keys (1, 2, 3, and 4) are prepared in this example. By selecting one of those keys, a character string to form the encryption key which is used in the WEP is selected, so that the encryption keys for the WEP which are peculiar to four kinds of terminals can be issued. If there are four or more kinds of terminals, the same key can be overlappingly used. If the user wants to use a different encryption key for every terminal, for example, it is sufficient to set the WPA. In the WPA, the length of secret key is set so as to cope with 128 bits, thereby enabling all terminals to own the individual secret keys. By selecting “valid” as a key mask 118, it is possible to hide the issued key.

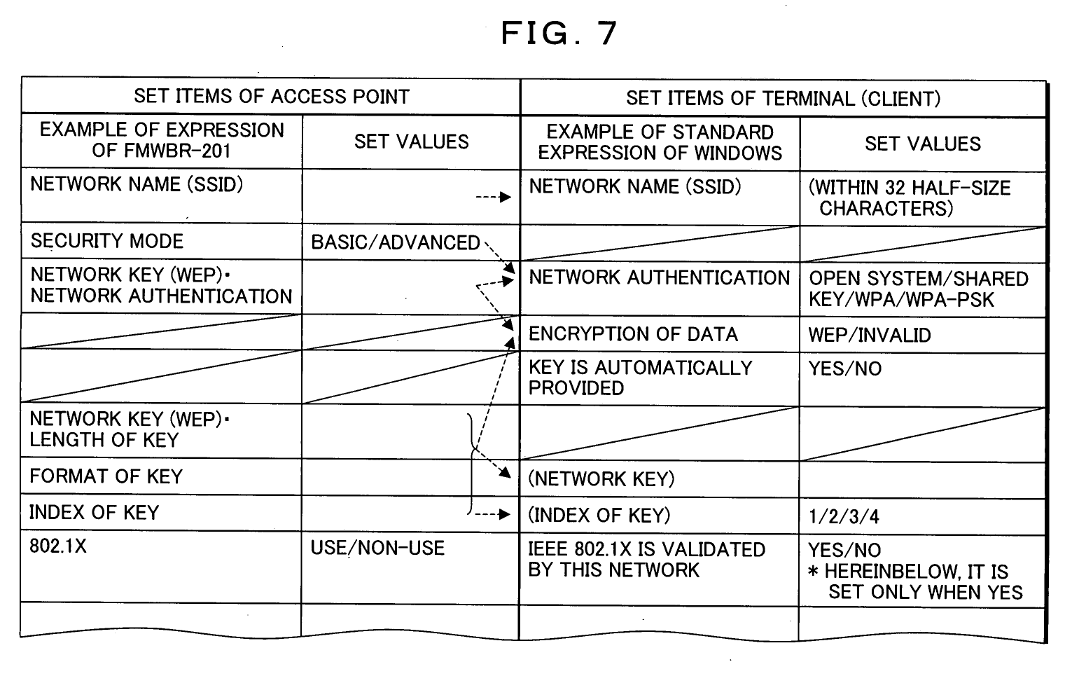

FIG. 7 is a correspondence explanatory diagram of the access point set items and the terminal set items which were set by the setting display screens in FIGS. 5 and 6. In FIG. 7, in the access point set items, an expression example of “FMWBR-201” as an access point made by Fujitsu Ltd. is shown. In FIG. 7, the set information corresponding to setting display screens in FIGS. 5 and 6 is shown as a part of the set items. As other set items, for example, necessary information is set by opening a property of the set items in, for example, Windows (registered trademark).

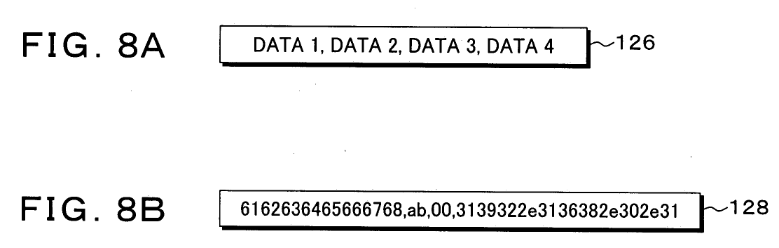

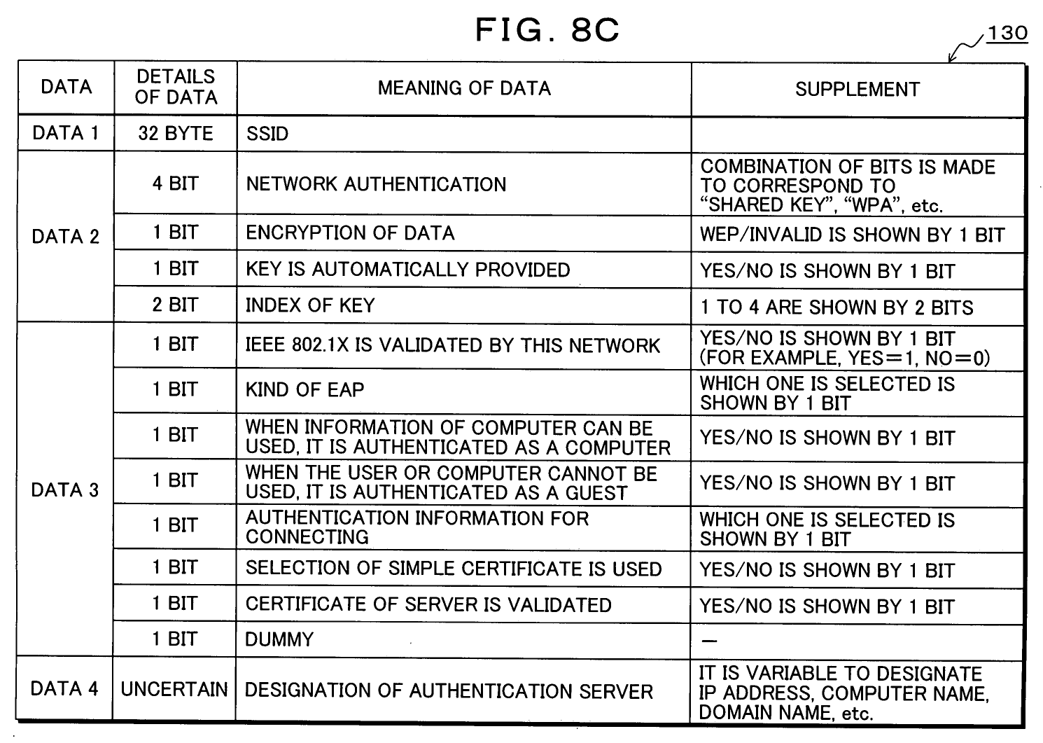

FIGS. 8A, 8B, and 8C are explanatory diagrams of set data which is held in the access point 10 by the setting process of the connection information and the authentication information. FIG. 8A shows a fundamental format of set data 126 which is held in the access point 10 and it has a data structure in which data 1, data 2, data 3, and data 4 are coupled by commas.

Set data 128 in FIG. 8B has a specific data structure and the case where the hexadecimal notation is used and the character string uses the ASCII code is shown as an example. The hexadecimal character string is described in correspondence to each of the data 1, data 2, data 3, and data 4 partitioned by the commas in the set data 126 in FIG. 8A.

FIG. 8C is a detailed explanatory diagram in the data 1 to 4 in the set data 126 in FIG. 8A. Details of the data, a meaning of the data, and a supplement are shown in correspondence to each data. In details 130 of the set data in FIG. 8C, the data 1 is a network name. The data 2 is data for the encrypted communication by the WEP. The data 3 is data for an authentication operating procedure (EAP: Extensible Authentication Protocol). Further, the data 4 is information in the case where the secret keys which are used in the WEP and EPA are obtained as a certificate from the server.

By writing the set information and the authentication information which are set into the access point and shown in FIGS. 8A to 8C as mentioned above into the memory card 18 and connecting to the terminal 12, as shown in FIG. 7, the set items of the terminal are extracted from the memory card 18 as necessary in correspondence to the set items of the access point and the setting for connection to the access point by the wireless LAN and the setting of the authentication information can be realized.

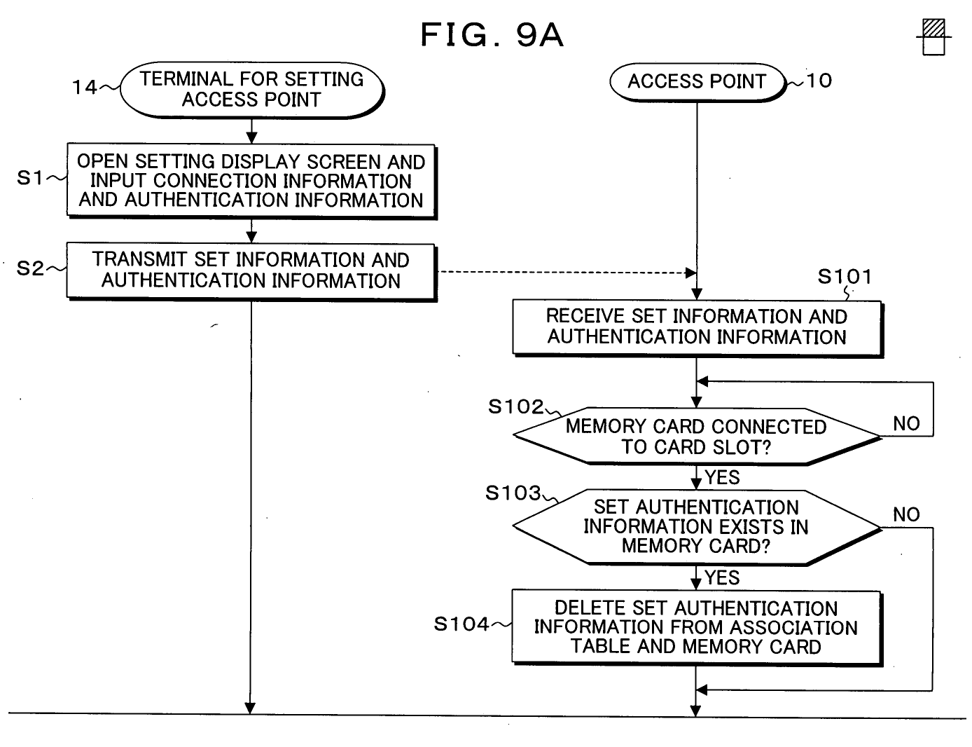

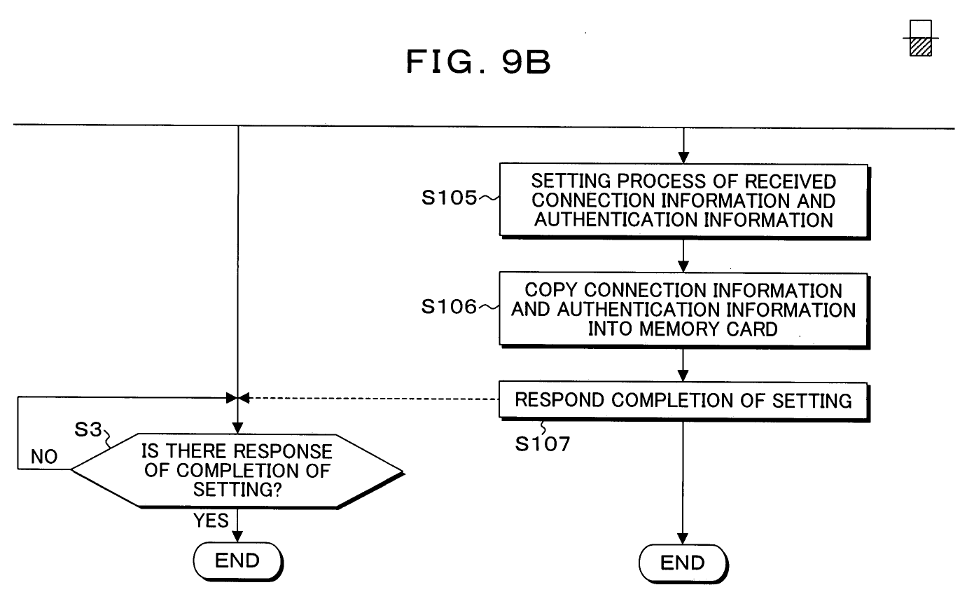

FIGS. 9A and 9B are time charts for the setting process between the access point setting terminal 14 and the access point 10 in FIGS. 3A and 3B. In FIGS. 9A and 9B, the access point setting terminal 14 inputs the set information and the authentication information by opening the setting display screens as shown in FIGS. 5 and 6 in step Si. Subsequently, in step S2, the inputted set information and authentication information are transmitted to the access point 10 and the setting is instructed. The access point 10 receives the set information and the authentication information from the access point setting terminal 14 in step S101. In step S102, whether or not the memory card 18 has been connected to the card slot is discriminated. If the memory card 18 has been connected, step S103 follows and whether or not the set authentication information remains in the memory card 18 is discriminated. If the set authentication information remains in the memory card 18, this means that the memory card which was issued once is issued again. In this case, the set authentication information is deleted from the association table 68 and the memory card 18 in step S104.

On the other hand, in the case where the first memory card in which the set authentication information does not remain in the memory card is issued in step S103, the setting process of the received connection information and authentication information is executed in step S105. After that, the set information and the authentication information are copied into the memory card in step S106. This is true of the case where the authentication information is deleted in order to issue the memory again in step S104. In step S107, the access point setting terminal 14 is notified of the completion of the setting. In response to this notification, the access point setting terminal 14 finishes the processing routine in step S3.

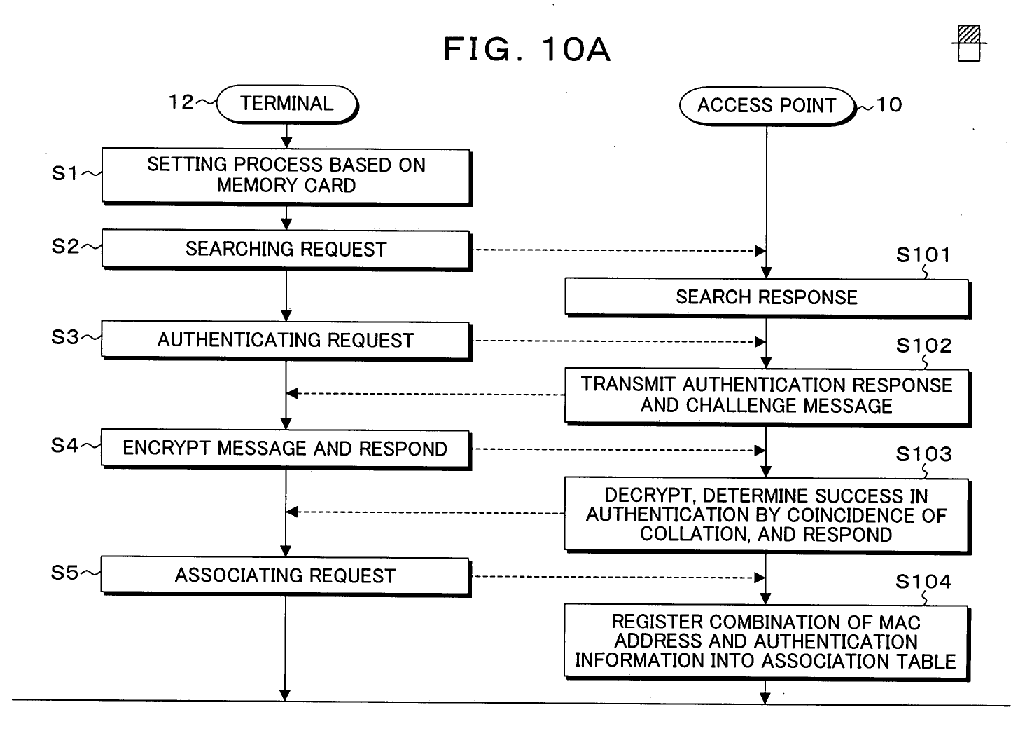

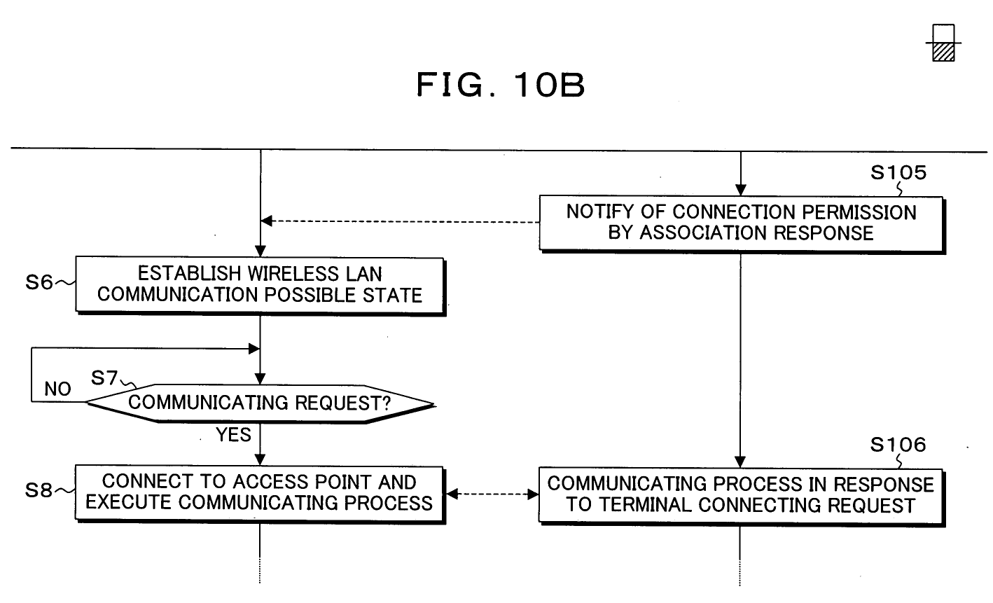

FIGS. 10A and 10B are time charts for a connecting process between the terminal and the access point in FIGS. 3A and 3B. In FIGS. 10A and 10B, in the terminal 12, the necessary information is read out from the memory card 18 connected to the card slot in step Si and the setting process of the connection information and authentication information for the connection by the wireless LAN is executed. When the setting process is finished, step S2 follows. To search for the access point, the probe request packet is transmitted as a search request to the access point 10. The access point 10 which received the probe request packet transmits the probe response packet to the terminal 12 by making a response to the search in step S101.

The terminal 12 which received the probe response packet from the access point 10 issues an authenticating request to the access point 10 in step S3. The access point 10 returns the authentication response in step S102 and, at the same time, transmits the challenge text of a length of 3 to 255 bytes. The terminal 12 encrypts the received challenge text by the secret key and returns it as a response message to the access point 10 in step S4. If the message decrypted by using the same secret key coincides with the first transmitted challenge text, the access point 10 makes a response of the success in the authentication in step S103.

Subsequently, the terminal 12 transmits the association request packet as an association request in order to obtain the permission of the communication connection to the access point 10 in step S5. The access point 10 registers the combination of the MAC address as an identifier that is peculiar to the terminal and the authentication information into the association table 68 in step S104 and notifies the terminal of the connection permission by the association request packet in step S105. In step S6, the terminal 12 receives the association request packet and recognizes the connection permission by the access point 10, thereby establishing the state where the wireless LAN communication with the access point 10 is possible.

Subsequently, if the communicating request is discriminated by the execution of an arbitrary application in step S7, the connecting request including an association identifier is made to the access point 10 in step S8. In step S106, the access point 10 which received the connecting request collates and compares the received combination of the authentication information and the MAC address with the combination of the MAC address and the authentication information registered in the association table 68 and, when they coincide, the access point 10 makes a response of the connection permission. Thus, the communication connection by the wireless LAN between the terminal 12 and the access point 10 is established and the communicating process is executed.

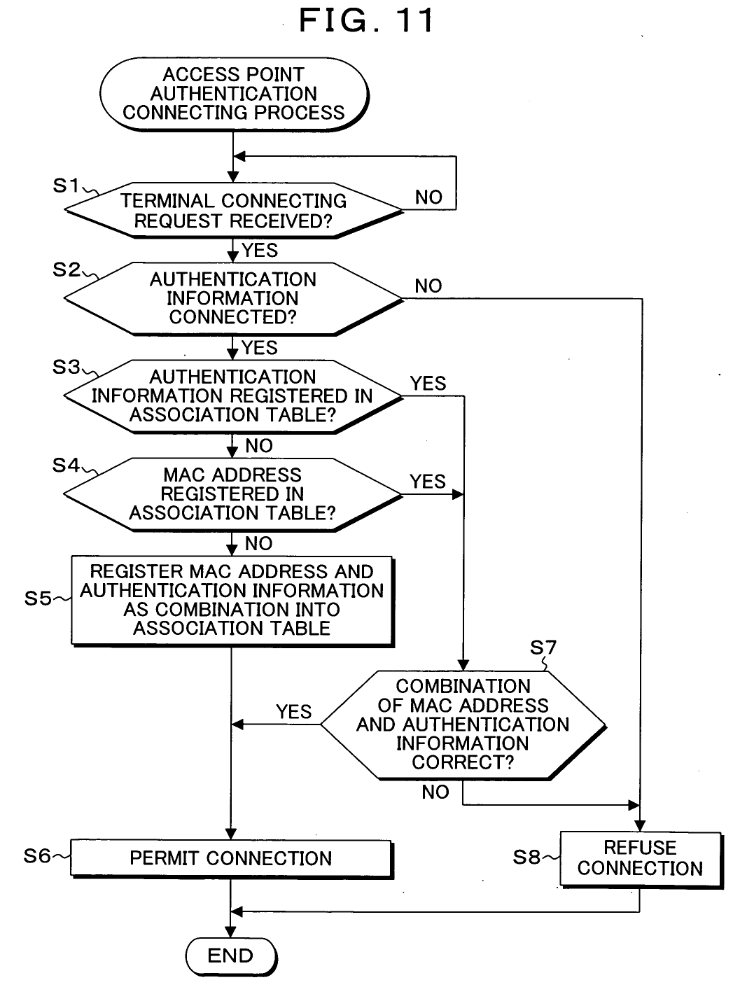

FIG. 11 is a flowchart for the authentication connecting process in the access point 10 in FIGS. 3A and 3B. In FIG. 11, the access point 10 discriminates whether or not the connecting request from the terminal has been received in step S1. When the connecting request is received, step S2 follows and the authenticating process is executed. The authenticating process is executed in accordance with the following procedure.

(1) When the authentication response is returned in response to the authenticating request of the terminal 12, the challenge text is transmitted simultaneously with it.

(2) An encrypted response message of the challenge text by the terminal 12 is received.

(3) The received encrypted message is decrypted.

(4) The challenge text is compared with the decrypted message and if they coincide, a response of the success in the authentication is made.

If the authentication is successful because the authentication information is determined to be correct, the processing routine advances to step S3. Whether or not the authentication information has been registered in the association table 68 is discriminated. At this time, if the connecting request from the terminal is the first access for obtaining the communication connection permission from the access point, this means that no authentication information is not registered in the association table 68. Therefore, step S4 follows and whether or not the MAC address has been registered in the association table 68 is discriminated. In the case of the first access, since no MAC address has been registered, step S5 follows. The MAC address is registered in the association table 68 as a set together with the authentication information. After it is registered, a response of the connection permission is made to the terminal in step S6.

In response to the connecting request from the terminal after the combination of the authentication information and the MAC address was registered into the access point, it is determined in step S2 that the authentication information is correct. It is determined in step S3 that the authentication information has been registered in the association table, and step S7 follows. In step S7, the combination of the MAC address and the authentication information is compared and collated with the combination of the MAC address and the authentication information registered in the association table, thereby discriminating whether or not the combination is correct. If it is correct, the connection is permitted.

On the other hand, if it is determined in step S2 that the received authentication information is incorrect because the authentication failed, the connection is refused in step S8. Also in the case where the combination of the authentication information and the MAC address registered in the association table does not coincide with the received combination of the MAC address and the authentication information and the combination is incorrect, the connection is refused in step S8.

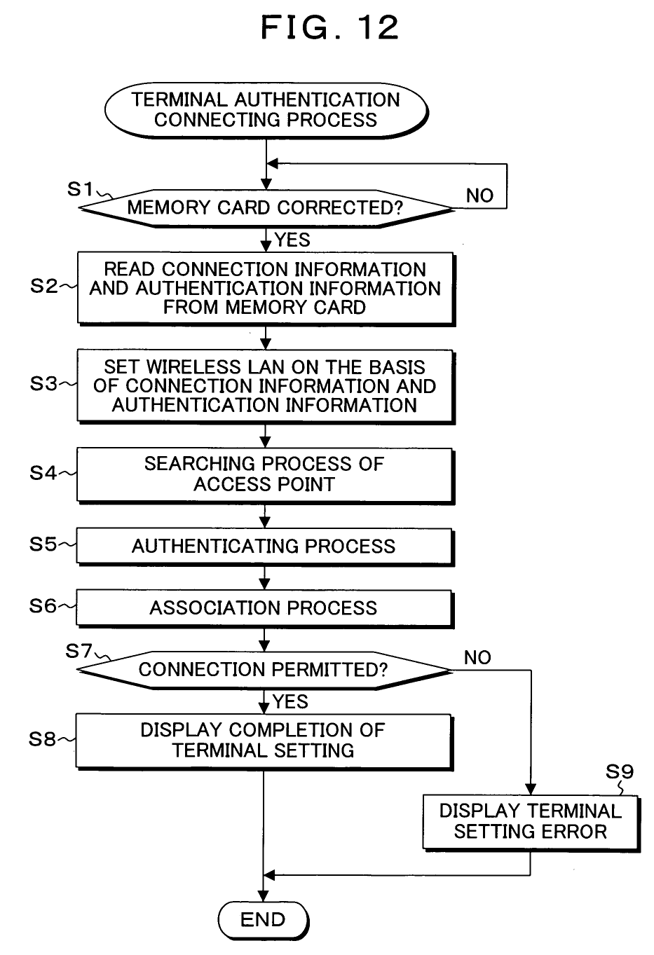

FIG. 12 is a flowchart for the authentication connecting process at the terminal 12 in FIGS. 3A and 3B. In FIG. 12, the terminal 12 discriminates whether or not the memory card has been connected. If the memory card has been connected, step S2 follows and the connection information and the authentication information are read out from the memory card. In step S3, the setting necessary for the wireless LAN is made on the basis of the read-out connection information and authentication information.

Subsequently, in step S4, the probe request packet is transmitted to the access point as a searching process of the access point. The access point which received the probe response packet is registered onto the access point list 80. Specifically speaking, the network name by the SS-ID is displayed as a connectable network. In step S5, one of the access points registered on the access point list 80 is selected and the authenticating process is executed. In this authenticating process, the authenticating request is issued to the access point 10, the authentication response and the challenge text are received, the received challenge text is encrypted by the secret key and returned as a response message to the access point 10, and a response of the success or failure of the authentication is received. When the authentication is successful in step S5, the associating process to obtain the connection permission is executed. In the associating process, the association request packet is transmitted to the access point and the association response packet as a notification of the connection permission based on the combination of the MAC address and the authentication information to the association table of the access point is received.

If there is the connection permission as an association response in step S7, the completion of the terminal setting is displayed in step S8. If the connection permission cannot be received, a terminal setting error is displayed in step S9. If the terminal setting error is displayed in step S9, since there is a possibility that the authentication information written in the memory card 18 has illegally been used in the access point for the purpose of permitting the connection to another terminal, it is necessary to remove the memory card from the terminal, insert it into the card slot of the access point 10 again, receives the reissuance by the resetting of the connection information and the authentication information, and execute the setting process of the terminal by the memory card which received the reissuance.

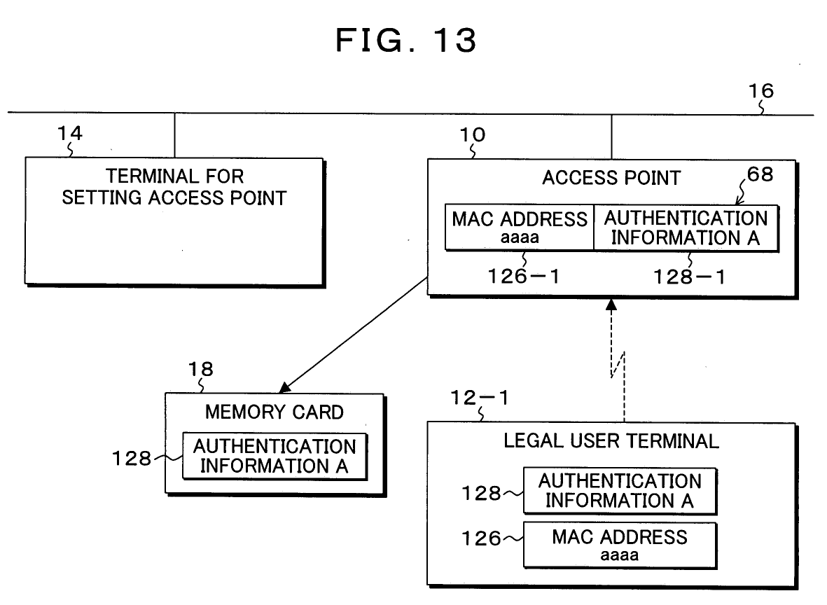

FIGS. 13 to 17 are explanatory diagrams showing such processes that the connection permission by the registration of the association table by the illegal terminal which illegally obtained the authentication information is performed to the access point 10 in FIGS. 3A and 3B, after that, the registration is deleted by the reissuance of the memory card, and the access of the illegal user terminal is inhibited.

FIG. 13 shows the state where the connection information and the authentication information have been set at the access point 10 by the instruction from the access point setting terminal 14, they have been written as authentication information 128-1 “authentication information A” into the memory card 18 by the completion of the setting in addition to the connection information, and the memory card 18 has been issued. It is assumed that in this state, the illegal user has illegally obtained the “authentication information A”, has obtained the connection permission to the access point 10 by using an illegal user terminal 120, and thereafter, has executed the access point searching operation, the authenticating operation, and the associating operation.

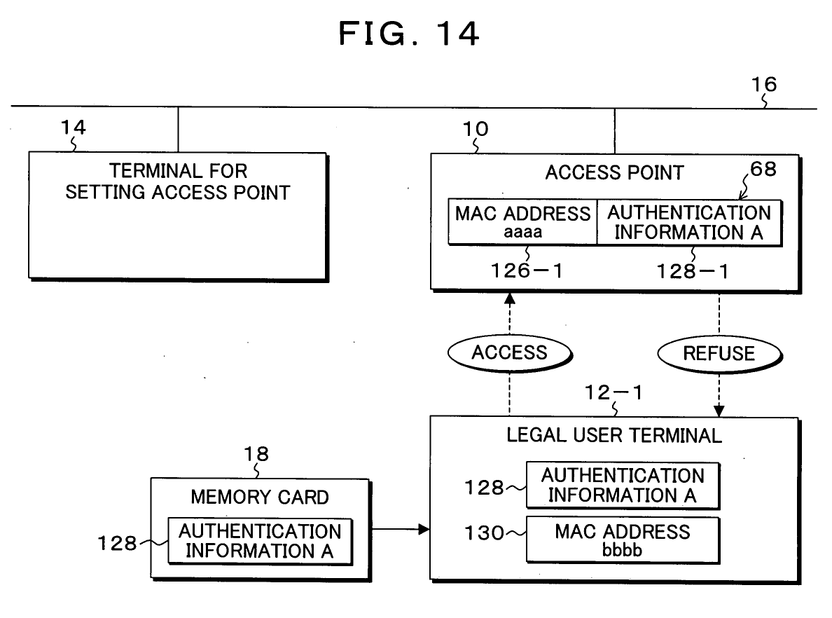

In response to such an access by the illegal user terminal 120, since the “authentication information A” is correct, the access point 10 registers a combination of “MAC address aaaa” as an MAC address 126-1 of the illegal user terminal 120 and the “authentication information A” as authentication information 128 which was illegally obtained into the association table 68 and notifies the illegal user terminal 120 of the connection permission. After-that, as shown in FIG. 14, it is assumed that the legal user who received the legal issuance of the memory card 18 has connected the memory card 18 to a legal user terminal 12-1, has read out the necessary information, has completed the setting necessary for the wireless LAN connection to the access point 10, and thereafter, has executed the access to obtain the connection permission, that is, the access point searching operation, the authenticating operation, and the associating operation.

In the case where the association request packet is transmitted in this authenticating operation, with respect to the “authentication information A” as authentication information 128 received from the legal user terminal 12-1, since the same encryption key as that of the “authentication information A” registered in the access point 10 is used, the access point 10 determines that the authentication information is correct. However, when the combination of the MAC address 126-1 and the authentication information 128-1 (MAC address aaaa, authentication information A) is compared with the combination of an MAC address 130 and the authentication information A (MAC address bbbb, authentication information A) received from the legal user terminal 12-1 with reference to the association table 68, since the combination is incorrect, the connecting request from the legal user terminal 12-1 is refused.

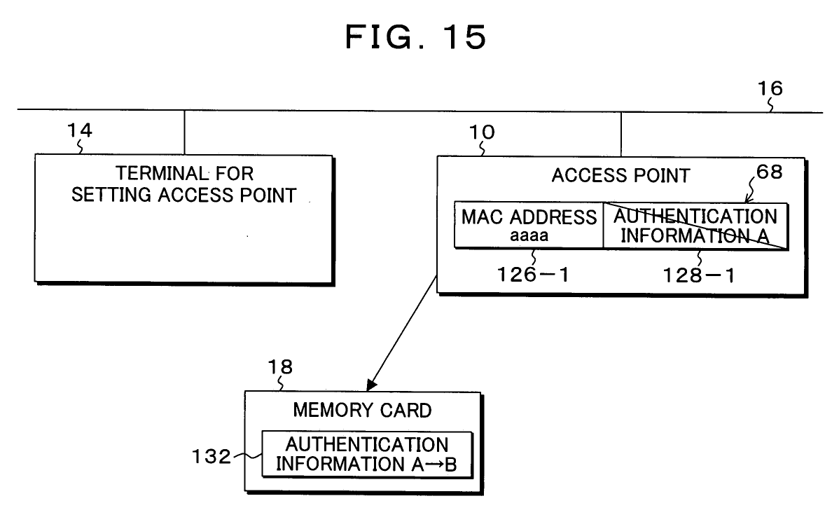

Since the authentication information 128-1 of the memory card 18 cannot be used, the legal user of the legal user terminal 12-1 which recognized the refusal result from the access point in response to such a connecting request connects the memory card 18 to the access point 10 again as shown in FIG. 15, makes the connecting request again and executes the setting process of the authentication information again to the access point 10 on the basis of the instruction by the access point setting terminal 14, writes new authentication information 132 into the memory card 18 by the completion of the connection, and receives the reissuance. By inserting the memory card 18 into the access point 10, it is determined that the set authentication information remains. The “authentication information A” as set authentication information in the memory card 18 is deleted and, at the same time, the “authentication information A” as authentication information 128-1 registered in the association table 68 is also deleted. New authentication information B issued to issue the memory card 18 again is written as authentication information 132 into the memory card 18.

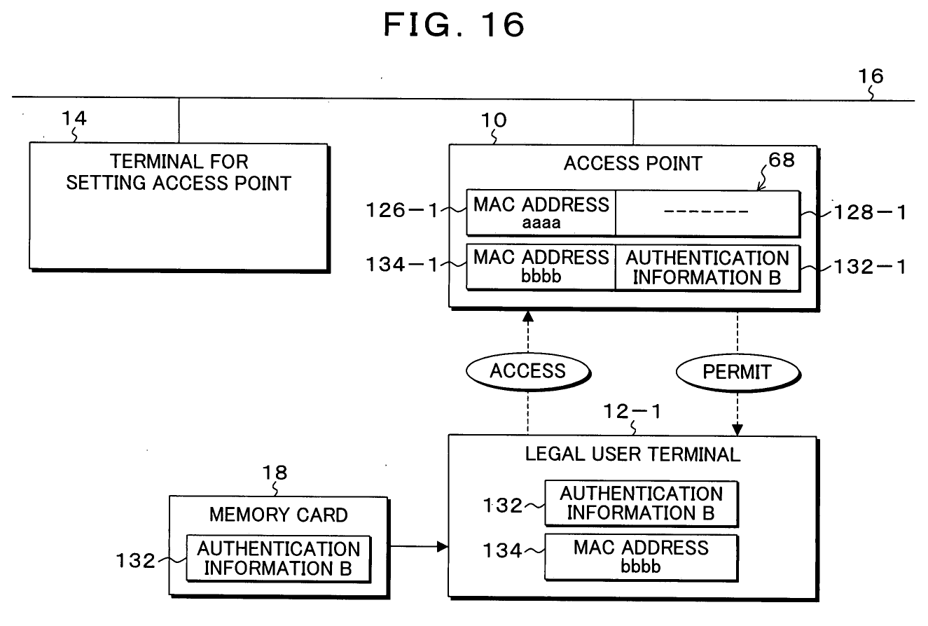

FIG. 16 shows the setting of the connection information and the authentication information by the legal user terminal 12-1 using the memory card 18 which was issued again in FIG. 15 and the subsequent the connecting request to the access point 10. In this case, the legal user terminal 12-1 has executed the authenticating operation and the associating operation by using the “authentication information B” as authentication information 132 which was newly issued. After the “authentication information B” was determined to be the correct authentication information at the access point 10, the legal user terminal 12-1 registers the information of (MAC address bbbb, authentication information B) as a combination of the authentication information 132 into the association table 68 together with an MAC address 134-1 of the legal user terminal 12-1 and makes a response of the connection permission after the registration. The legal user terminal 12-1 can establish the wireless LAN communication connection to the access point 10 by the setting based on the connection information and the authentication information in the memory card 18 which was issued again.

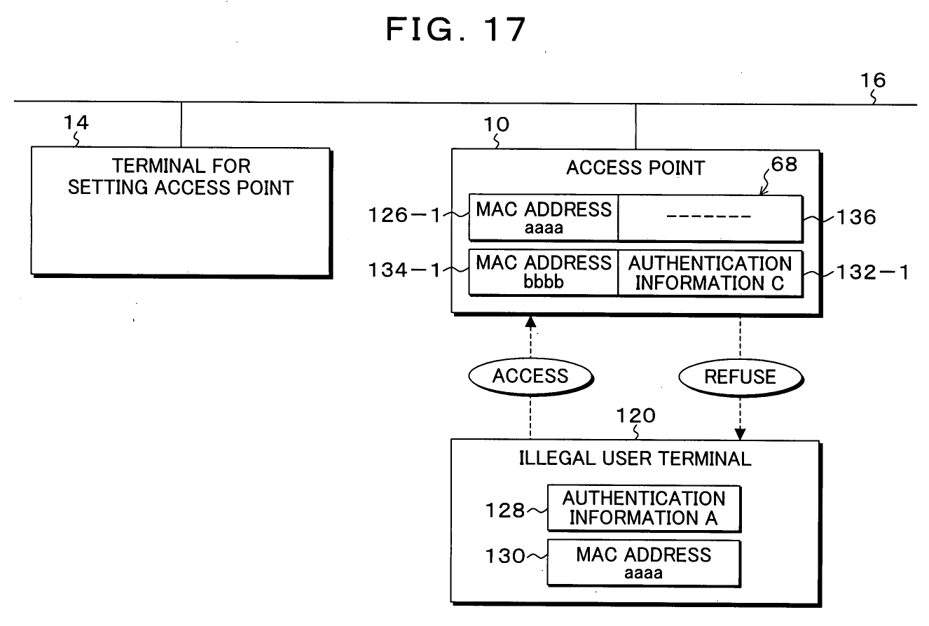

FIG. 17 shows the case where after the connection permission from the access point 10 to the legal user terminal 12-1 was issued by the reissuance of the memory card 18, the illegal user terminal 120 makes the connecting request to the access point 10. When the illegal user terminal 120 makes the connecting request, although the “authentication information A” as authentication information 128 is correct, with respect to authentication information 136 corresponding to the MAC address 126-1 of the illegal user terminal 120, its combination is (MAC address aaaa, no registration) and does not coincide with the received combination of the MAC address and the authentication information (MAC address aaaa, authentication information A), and it is the wrong combination. Therefore, the access point 10 refuses the connecting request from the illegal user terminal 120.

As mentioned above, according to the invention, with respect to the memory card in which the connection information and the authentication information have been written and which was issued from the access point 10, even if the illegal user illegally obtained the authentication information and connected to the access point 10 by the impersonation, by issuing the memory card to the legal user again, the registration of the authentication information of the illegal user terminal 120 is deleted from the access point 10 and the subsequent connecting request by the illegal user terminal can be refused.

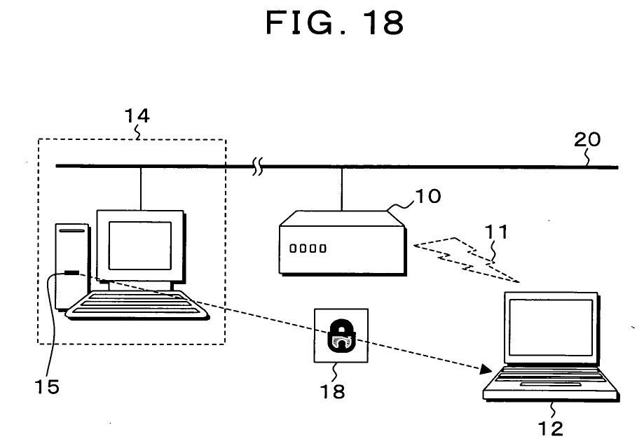

FIG. 18 is an explanatory diagram of a wireless LAN system which uses an access point having no card slot and to which the invention is applied. In FIG. 18, the access point 10 does not have the card slot to connect the memory card 18. Therefore, the writing of the connection information and the authentication information into the memory card 18 after completion of the setting to the access point 10 is executed by using the connection of the memory card 18 to the card slot 15 of the access point setting terminal 14. Other constructions are substantially the same as those in the embodiment of FIG. 1.

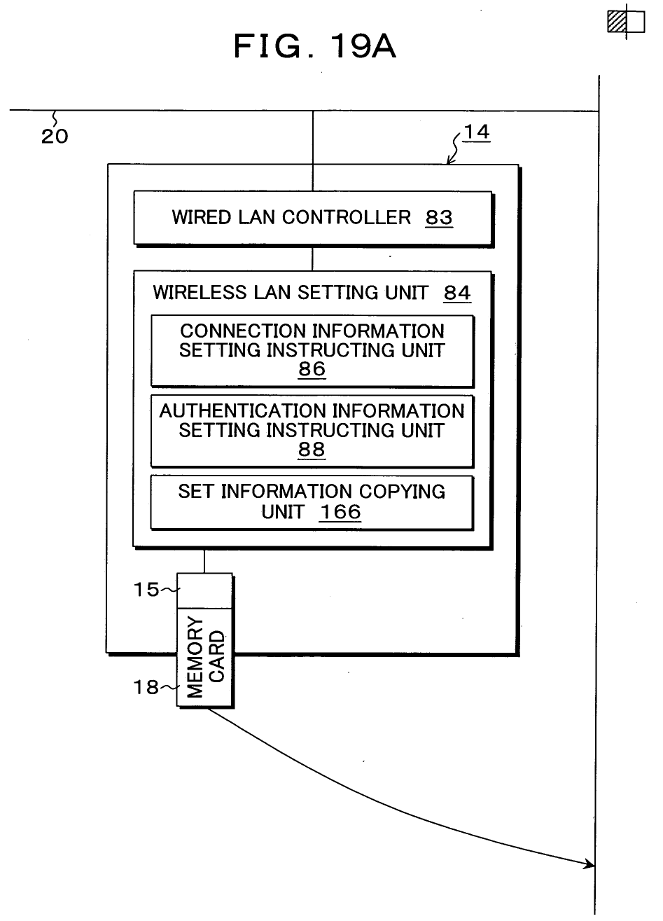

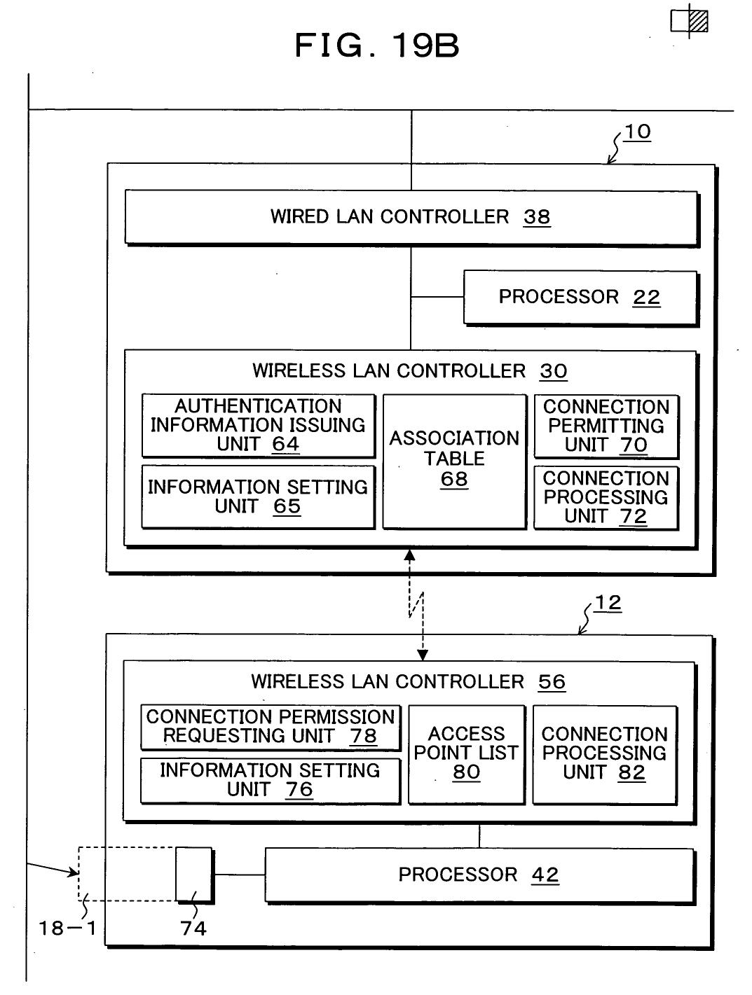

FIGS. 19A and 19B are block diagrams of functional constructions of the access point 10, the terminal 12, and the access point setting terminal 14 in FIG. 18. Although the construction of the access point 10 is fundamentally the same as that in the embodiment of FIGS. 3A and 3B, since the access point 10 does not have the card slot, the functions of the set information copying unit provided for the wireless LAN controller 30 in FIGS. 3A and 3B are eliminated. In place of them, a set information copying unit 166 is newly provided for the wireless LAN setting unit 84 of the access point setting terminal 14 having the card slot 15. Therefore, in the case where the connection information and the authentication information are set in the access point 10 by the instruction using the setting display screen from the access point setting terminal 14, the set connection information and authentication information are returned to the access point setting terminal 14 and written into the memory card 18 connected to the card slot 15 by the set information copying unit 166.

In a manner similar to the case of FIGS. 3A and 3B, the memory card 18 in which the connection information and the authentication information have been written at the access point setting terminal 14 is connected like a memory card 18-1 to the card slot 74 of the terminal 12, the information in the memory card 18-1 is read out as necessary, and the setting of the connection information and the authentication information for the wireless LAN connection at the terminal 12 is made. Other functions in the access point 10, the terminal 12, and the access point setting terminal 14 are substantially the same as those in the embodiment of FIGS. 3A and 3B.

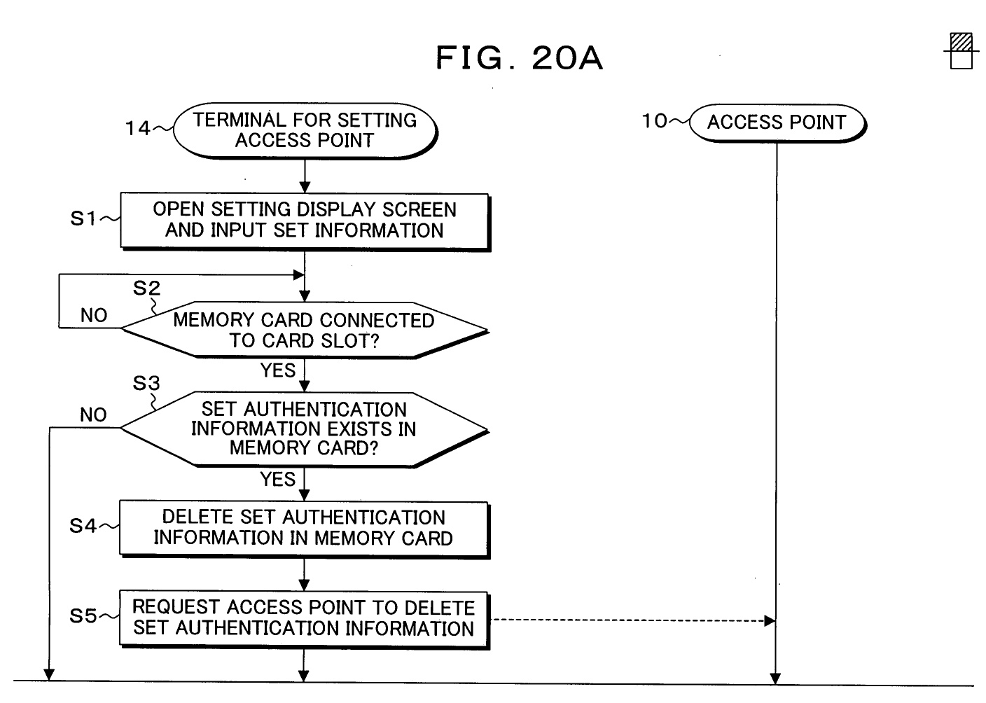

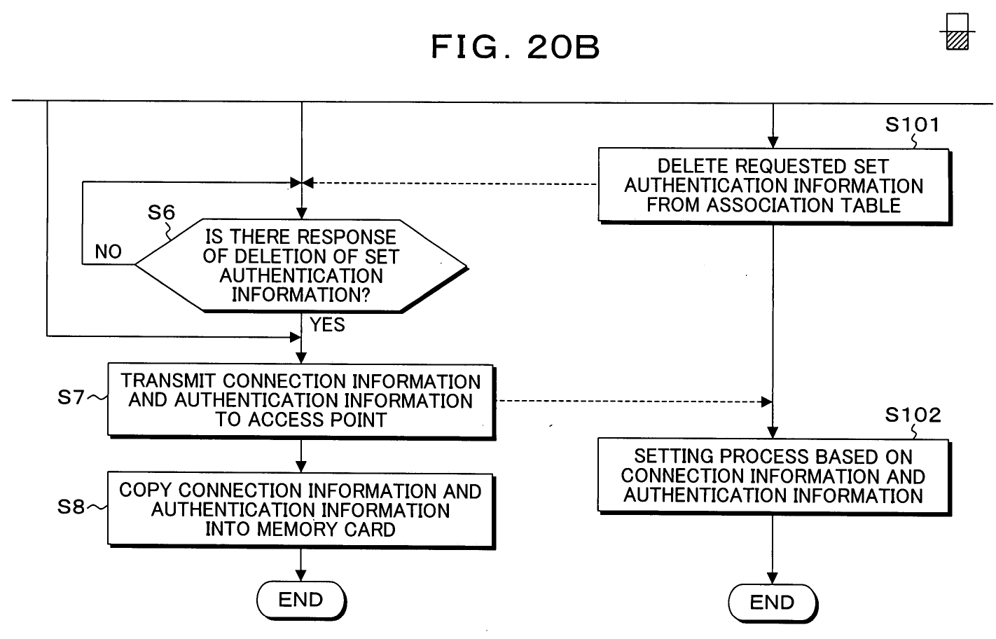

FIGS. 20A and 20B are time charts for the setting process between the access point setting terminal 14 and the access point 10 in FIGS. 19A and 19B. In FIGS. 20A and 20B, the access point setting terminal 14 opens the setting display screens as shown in FIGS. 5 and 6 and inputs the set information in step S1. Subsequently, whether or not the memory card 18 has been connected to the card slot is discriminated in step S2. If it is connected, step S3 follows and whether or not the set authentication information issued before remains in the memory card 18 is discriminated.

If the memory card has been issued for the first time, the set authentication information does not remain. Therefore, step S7 follows and the copying process for writing the set information and the authentication information into the memory card 18 is executed. If it is determined in step S3 that the memory card 18 has been issued again, the set authentication information remains in the memory card 18. Therefore, in this case, step S4 follows and the set authentication information in the memory card 18 is deleted. In next step S5, the access point 10 is requested to delete the set authentication information.

In response to such a deleting request, the access point 10 deletes the requested authentication information from the association table 68 and finishes the process after completion of the deletion. In step S6, the access point setting terminal 14 is waiting for a response to the deletion of the set authentication information. When the deletion response is received, the access point setting terminal 14 transmits the connection information and the authentication information which were newly set to the access point in step S7. The access point 10 executes the setting process based on the connection information and the authentication information in step S102. When the setting completion is received in step S8, the access point executes the copying process for writing the set information and the authentication information into the memory card 18 and issues the memory card 18 again.

By such deletion of the set authentication information in the memory card in the reissuance of the memory card 18 and the set authentication information from the association table at the access point as mentioned above, the authentication information in the association table registered by the illegal user terminal is deleted. The subsequent connecting request by the illegal user terminal can be refused.

A processing procedure between the terminal 12 and the access point 10 in the embodiment of FIGS. 19A and 19B is substantially the same as that shown in the time chart of FIGS. 10A and 10B. An authentication connecting process of the access point is substantially the same as that shown in the flowchart of FIG. 11. Further, an authentication connecting process of the terminal 12 is also substantially the same as that shown in the flowchart of FIG. 12.

The invention provides an access point control program which is executed by the wireless LAN controller 30 of the access point shown in FIGS. 19A and 19B. The access point control program has the processing procedure of the flowchart for the access point authentication connecting process shown in FIG. 11. Although the above embodiment has been described with respect to the example in which the personal computer is used as a terminal 12, the invention also incorporates the case where other proper terminals such as a PDA and the like which can be communication connected with the access point 10 by the wireless LAN. Although the above embodiment has been described with respect to the example in the case where the wireless LAN card is attached to the terminal 12 and used, the invention can be also applied to a type in which the card is fixedly mounted as a wireless LAN port to the terminal itself. Further, although the above embodiment has been described with respect to the example of the wireless LAN of IEEE802.11, the invention is not limited to it but can be also applied as it is to the wireless LAN using a proper system.

The present invention incorporates many proper variations and modifications without losing the objects and advantages of the invention and is not limited by the numerical values shown in the foregoing embodiment.

In the claims:

1. A control program for allowing a communication relay apparatus which is connected to a communicating apparatus by a wireless network to execute:
an information setting step wherein connection information of said communication relay apparatus and authentication information of said communicating apparatus which is connected by said wireless network by an instruction from a communicating apparatus for setting information;
a set information copying step wherein said connection information and said authentication information are copied into a portable recording medium connected to said communication relay apparatus;
a connection permitting step wherein when a first connecting request is received from said communicating apparatus in which the connection information and the authentication information of said wireless network have been set by the connection of said portable recording medium, a combination of an identifier of said communicating apparatus and the authentication information is registered into management information under a condition that the received authentication information is correct and said communicating apparatus is notified of connection permission; and
a connection processing step wherein when said connecting request is received from said communicating apparatus after the notification of said connection permission, a received combination of the identifier of the communicating apparatus and the authentication information is compared with the combination of the identifier of the communicating apparatus and the authentication information registered in said management information, when the combination is correct, the connection is permitted, and when the combination is incorrect, the connection is refused.

2. A program according to claim 1, wherein in said set information copying step, if the set authentication information has been copied into said portable recording medium connected to said communication relay apparatus, said set copy information is deleted from said portable recording medium and said management information and, thereafter, the set information instructed from said information setting communicating apparatus and new authentication information are copied.

3. A control program for allowing a communication relay apparatus which is connected to a communicating apparatus by a wireless network to execute:
an information setting step wherein connection information of said communication relay apparatus and authentication information of said communicating apparatus which is connected by said wireless network are set by an instruction from a communicating apparatus for setting information;
a set information copying step wherein said connection information and said authentication information are copied into a portable recording medium connected to said information setting communicating apparatus;
a connection permitting step wherein when a first connecting request is received from said communicating apparatus in which the connection information and the authentication information of said wireless network have been set by the connection of said portable recording medium, a combination of an identifier of said communicating apparatus and said authentication information is registered into management information under a condition that the received authentication information is correct and said communicating apparatus is notified of connection permission; and
a connection processing step wherein when said connecting request is received from said communicating apparatus after the notification of said connection permission, a received combination of the identifier of the communicating apparatus and the authentication information is compared with the combination of the identifier of the communicating apparatus and the authentication information registered in said management information, when the combination is correct, the connection is permitted, and when the combination is incorrect, the connection is refused.

4. A program according to claim 1, wherein in said information setting step, said set authentication information is deleted from said management information on the basis of a deleting instruction of the set authentication information in the case where the set authentication information has been copied into said portable recording medium from said information setting communicating apparatus and, thereafter, the set information instructed from said information setting communicating apparatus and new authentication information are set into said portable recording medium.

5. A program according to claim 1, wherein the identifier of said communicating apparatus is an MAC address of said communicating apparatus.

6. A communication relay apparatus control method comprising:
an information setting step wherein connection information of a communication relay apparatus and authentication information of a communicating apparatus which is connected by a wireless network are set by an instruction from a communicating apparatus for setting information;
a set information copying step wherein said connection information and said authentication information are copied into a portable recording medium connected to said communication relay apparatus;
a connection permitting step wherein when a first connecting request is received from said communicating apparatus in which the connection information and the authentication information of said wireless network have been set by the connection of said portable recording medium, a combination of an identifier of said communicating apparatus and said authentication information is registered into management information under a condition that the received authentication information is correct and said communicating apparatus is notified of connection permission; and
a connection processing step wherein when said connecting request is received from said communicating apparatus after the notification of said connection permission, a received combination of the identifier of the communicating apparatus and the authentication information is compared with the combination of the identifier of the communicating apparatus and the authentication information registered in said management information, when the combination is correct, the connection is permitted, and when the combination is incorrect, the connection is refused.

7. A method according to claim 6, wherein in said set information copying step, if the set authentication information has been copied into said portable recording medium connected to said communication relay apparatus, said set copy information is deleted from said portable recording medium and said management information and, thereafter, the set information instructed from said information setting communicating apparatus and new authentication information are copied.

8. A communication relay apparatus control method comprising:
an information setting step wherein connection information of a communication relay apparatus and authentication information of a communicating apparatus which is connected by a wireless network are set by an instruction from a communicating apparatus for setting information;
a set information copying step wherein said connection information and said authentication information are copied into a portable recording medium connected to said information setting communicating apparatus;
a connection permitting step wherein when a first connecting request is received from said communicating apparatus in which the connection information and the authentication information of said wireless network have been set by the connection of said portable recording medium, a combination of an identifier of said communicating apparatus and the authentication information is registered into management information under a condition that the received authentication information is correct and said communicating apparatus is notified of connection permission; and
a connection processing step wherein when said connecting request is received from said communicating apparatus after the notification of said connection permission, a received combination of the identifier of the communicating apparatus and the authentication information is compared with the combination of the identifier of the communicating apparatus and the authentication information registered in said management information, when the combination is correct, the connection is permitted, and when the combination is incorrect, the connection is refused.

9. A method according to claim 8, wherein in said information setting step, said set authentication information is deleted from said management information on the basis of a deleting instruction of the set authentication information in the case where the set authentication information has been copied into said portable recording medium from said information setting communicating apparatus and, thereafter, the set information instructed from said information setting communicating apparatus and new authentication information are set.

10. A communication relay apparatus comprising:
an information setting unit which sets connection information of the communication relay apparatus and authentication information of a communicating apparatus which is connected by a wireless network by an instruction from a communicating apparatus for setting information;
a set information copying unit which copies said connection information and said authentication information into a connected portable recording medium;
a connection permitting unit which, when a first connecting request is received from said communicating apparatus in which the connection information and the authentication information of said wireless network have been set by the connection of said portable recording medium, registers a combination of an identifier of said communicating apparatus and the authentication information into management information under a condition that the received authentication information is correct and notifies said communicating apparatus of connection permission; and
a connection processing unit which, when said connecting request is received from said communicating apparatus after the notification of said connection permission, compares a received combination of the identifier of the communicating apparatus and the authentication information with the combination of the identifier of the communicating apparatus and the authentication information registered in said management information, permits the connection when the combination is correct, and refuses the connection when the combination is incorrect.

11. An apparatus according to claim 10, wherein if said set authentication information has been copied in said connected portable recording medium, said set information copying unit deletes said set copy information from said portable recording medium and said management information and, thereafter, copies the set information instructed from said information setting communicating apparatus and new authentication information.

12. A communication relay apparatus comprising:
an information setting unit which sets connection information of the communication relay apparatus and authentication information of a communicating apparatus which is connected by a wireless network by an instruction from a communicating apparatus for setting information;
a set information copying unit which copies said connection information and the authentication information into a portable recording medium connected to said information setting communicating apparatus;
a connection permitting unit which, when a first connecting request is received from said communicating apparatus in which the connection information and the authentication information of said wireless network have been set by the connection of said portable recording medium, registers a combination of an identifier of said communicating apparatus and the authentication information into management information under a condition that the received authentication information is correct and notifies said communicating apparatus of connection permission; and
a connection processing unit which, when said connecting request is received from said communicating apparatus after the notification of said connection permission, compares a received combination of the identifier of the communicating apparatus and the authentication information with the combination of the identifier of the communicating apparatus and the authentication information registered in said management information, permits the connection when the combination is correct, and refuses the connection when the combination is incorrect.

13. An apparatus according to claim 12, wherein said information setting unit deletes said set authentication information from said management information on the basis of a deleting instruction of the set authentication information in the case where the set authentication information has been copied into said portable recording medium from said information setting communicating apparatus and, thereafter, sets the set information instructed from said information setting communicating apparatus and new authentication information.

14. A system comprising:
a communication relay apparatus to which a portable recording medium is connected;
a communicating apparatus which is connected to said communication relay apparatus by a wireless network and to which said portable recording medium can be connected; and
an information setting communicating apparatus for instructing said communication relay apparatus to set connection information and authentication information of said communicating apparatus,
wherein said communication relay apparatus comprises:
an information setting unit which sets the connection information of the communication relay apparatus and the authentication information of the communicating apparatus which is connected by said wireless network by the instruction from said information setting communicating apparatus;
a set information copying unit which copies said connection information and said authentication information into said connected portable recording medium;
a connection permitting unit which, when a first connecting request is received from said communicating apparatus in which the connection information and the authentication information of said wireless network have been set by the connection of said portable recording medium, registers a combination of an identifier of said communicating apparatus and the authentication information into management information under a condition that the received authentication information is correct and notifies said communicating apparatus of connection permission; and
a connection processing unit which, when said connecting request is received from said communicating apparatus after the notification of said connection permission, compares a received combination of the identifier of the communicating apparatus and the authentication information with the combination of the identifier of the communicating apparatus and the authentication information registered in said management information, permits the connection when the combination is correct, and refuses the connection when the combination is incorrect.

15. A system according to claim 14, wherein if the set authentication information has been copied into said connected portable recording medium, said set information copying unit of said communication relay apparatus deletes said set copy information from said portable recording medium and said management information and, thereafter, copies the set information instructed from said information setting communicating apparatus and new authentication information.

16. A system comprising:
a communication relay apparatus;
a communicating apparatus which is connected to said communication relay apparatus by a wireless network and to which a portable recording medium can be connected; and
an information setting communicating apparatus to which said portable recording medium is connected and which instructs said communication relay apparatus to set connection information and authentication information of said communicating apparatus,
wherein said information setting communicating apparatus comprises:
an information setting instructing unit which instructs the setting of the connection information of said communication relay apparatus and the authentication information of the communicating apparatus which is connected by said wireless network; and
a card copy processing unit which copies said connection information and said authentication information whose setting has been instructed to said communication relay apparatus into the connected portable recording medium, and
said communication relay apparatus comprises:
an information setting unit which sets the connection information of said communication relay apparatus and the authentication information of the communicating apparatus which is connected by said wireless network by the instruction from said information setting communicating apparatus;
a set information copying unit which copies said connection information and said authentication information into the portable recording medium connected to said information setting communicating apparatus;
a connection permitting unit which, when a first connecting request is received from said communicating apparatus in which the connection information and the authentication information of said wireless network have been set by the connection of said portable recording medium, registers a combination of an identifier of said communicating apparatus and the authentication information into management information under a condition that the received authentication information is correct and notifies said communicating apparatus of connection permission; and
a connection processing unit which, when said connecting request is received from said communicating apparatus after the notification of said connection permission, compares a received combination of the identifier of the communicating apparatus and the authentication information with the combination of the identifier of the communicating apparatus and the authentication information registered in said management information, permits the connection when the combination is correct, and refuses the connection when the combination is incorrect.

17. A system according to claim 16, wherein
in the case where the set authentication information has been copied into said connected portable recording medium, said card copying processing unit of said information setting communicating apparatus deletes the set authentication information from said portable recording medium, and
said information setting unit of said communication relay apparatus deletes said set authentication information from said management information on the basis of a deleting instruction from said information setting communicating apparatus and, thereafter, sets the set information instructed from said information setting communicating apparatus and new authentication information.
